(19) United States
(12) Patent Application Publication
(10) Pub. No.: US 2007/0294126 A1
(43) Pub. Date: Dec. 20, 2007

(54) Method and system for characterizing audiences, including as venue and system targeted (VAST) ratings

(76) Inventor: Frank S. Maggio, Pinellas Park, FL (US)

Correspondence Address: KING & SPALDING LLP, 1180 PEACHTREE STREET, ATLANTA, GA, 30309-3521, US

(21) Appl. No.: 11/657,384

(22) Filed: Jan. 24, 2007

Related U.S. Application Data
(60) Provisional application No. 60/761,673, filed on Jan. 24, 2006.

(51) Int. Cl. G06Q 10/00; G06F 17/18; G08B 1/08

(52) U.S. Cl. 705/10; 340/539.11

(57) ABSTRACT

A system for characterizing an audience can comprise instruments that monitor representative audience members for media exposure and an engine that deduces information about the audience as a whole. A set of instruments can monitor each representative audience member's media exposure. An in-home instrument, such as a set top box or a hand-held remote control, can monitor exposure to in-home television and radio. An in-vehicle instrument can monitor billboard and onboard radio exposure. A manual instrument, such as a diary, can monitor other media exposure. The engine can process exposure data from the instruments for each monitored member to form a comprehensive media exposure profile of venue and system targeted (“VAST”) ratings. The profile can segment exposure according to delivery system, media type, and venue. The engine can extrapolate the data obtained for each monitored member to provide segmented exposure and demographic information about the audience as a whole.

### RELATED APPLICATIONS

This application claims priority to U.S. Provisional Patent Application No. 60/761,673, filed Jan. 24, 2006 in the name of Frank Maggio, and entitled “Method and System for Characterizing Advertising Audiences,” the entire contents of which are hereby incorporated herein by reference.

This application is related to U.S. patent application Ser. No. 10/976,149, which was filed on Oct. 28, 2004, published as U.S. Patent Application Publication Number 2005/0060232 on Mar. 17, 2005 to Maggio, and entitled “Method and System for Interacting with a Writing,” the entire contents of which are hereby incorporated herein by reference.

### TECHNICAL FIELD

The present invention relates generally to characterizing media audiences and more specifically to using monitoring instruments to obtain media exposure information about an audience sample and deriving from that information an aggregate profile for the audience as a whole.

### BACKGROUND

In the traditional advertising model, broadcast media (e.g., television networks, radio stations, newspapers, magazines) develop entertainment content (e.g., a television show) of interest to consumers. The consumers are persons who may use an advertiser's commodity or service, and who view, hear, read, or otherwise absorb or become exposed to the entertainment content, as well as advertising content. The advertisers are entities that distribute the advertisements to induce the consumers to buy, use, or do something. The media deliver the entertainment content and the advertisements to the consumers (e.g., over the air, by cable transmission, or via print media mass distribution, outdoor media, Internet, or private network). Media may charge the consumers for entertainment content delivery, but typically media receive most revenue from the advertisers in exchange for delivering advertisements with the entertainment content.

Promoters initiate, develop, generate, and/or distribute entertainment content, attracting many of the consumers and, in turn, attracting the advertisers. The advertisers sponsor the entertainment content by paying the promoters to deliver the advertisements with the entertainment content. Advertising fees generally increase as the number of the consumers exposed to the advertisements increases. The promoters use the advertising fees to offset the promoters' costs to produce and distribute the advertising content and to make a profit. The consumers usually do not pay to see, hear, or otherwise absorb or become exposed to the entertainment content. The consumers also do not receive payment for seeing, hearing, or otherwise absorbing or becoming exposed to the advertisements. The consumers' traditional reward is the ability to see, hear, and enjoy the entertainment content for little or no charge in exchange for tolerating the advertisements.

Recent technological advancements (e.g., the Internet) have caused an increase in possible entertainment outlets. With this increase, the consumers are distracted by multiple entertainment forms. As a result, the advertisers have more difficulty reaching mass numbers of the consumers. In addition, the promoters have more difficulty guaranteeing that many of the consumers will watch, hear, read, or otherwise absorb or become exposed to the entertainment content and the advertisements. This phenomenon has led to lower advertising fees and lower profits for the promoters.

The advertisers' goal is to provide the consumers with memorable advertisements that include information on the advertisers' product or service. However, the consumers typically ignore or avoid the advertisements. The consumers often “tune out,” change the channel, skip a printed page, or walk away when the advertisements are presented. In addition, the consumers increasingly turn to less advertising-dependent entertainment forms (e.g., premium channels), or use technology (e.g., video recorders, personal recording devices (“PRDs”), remote controls, etc.) to skip the advertisements.

Perhaps the most ubiquitous device for avoiding advertising is a handheld remote control that allows the consumer to rapidly navigate among television channels. Remote controls have been recognized as the second most frequently used household appliance in the United States, behind only the refrigerator. Consumers often purchase new remote controls with enhanced features in conjunction with acquiring entertainment appliances such as televisions, stereos, digital videodisc/versatile disc (“DVD”) players, and video cassette recorders (“VCRs”). The new and enhanced remote control can interact with the acquired appliances as well as the consumer's preexisting or “legacy” appliances.

Advertising, whether delivered via a printed or an electronic medium, can be divided into two classes: mass media advertising and targeted advertising. Mass media advertising (e.g., over a broadcast network such as television, cable, satellite, radio, newspaper, magazine, mass mail, mass e-mail, streaming Internet, etc.) sends broadly based advertising messages to a wide spectrum of the consumers. Mass media broadcasting of advertisements comprises presenting one or more advertisements through the broadcast network such that anyone receiving the broadcast network receives essentially the same advertising content, regardless of the person's demographics or other criteria. For example, each person tuning into the same television channel, streaming Internet website, or radio station, or reading the same magazine page, newspaper page, or billboard, will receive the same entertainment and advertisement content. Accordingly, those advertisements comprise mass media broadcast advertisements. On the other hand, targeted advertising focuses on delivering specific, personalized advertising to the consumers that meet a demographic profile specified by the advertisers. Mass media advertising is usually less expensive per impression than targeted advertising. However, targeted advertising is usually more effective and has become less expensive per impression as technology has progressed. As a result, the effectiveness of mass media advertising has been questioned.

Both mass media advertising and targeted advertising find value in estimating the size and demographics of the audience for each segment of content offered to the consumers. Characterization of the audience facilitates a promoter pricing advertisement delivery at a level that accurately reflects value. With the proliferation of networking technologies, consumers often have an array of media alternatives from which a specific content selection can be made. This array of alternatives causes complexities in conventional methods for estimating audiences. For example, a segment of an audience that could be statistically insignificant from a mass advertising perspective might be a very significant portion of a highly targeted audience.

Often, one or more private content distribution networks offer content choices to a consumer or a household of consumers. The access controls of such private networks can limit accurately estimating and characterizing an audience for a specific content segment. For example, an owner of a private network, such as a cable television network, may restrict access to the network, thus hampering audience estimation by an independent party.

In one conventional approach to audience estimation, a content distribution network broadcasts content choices to each broadcast receiver, such as a television, on the network. Each broadcast receiver interfaces with the content distribution network via a device, known as a set top box, through with a consumer can make a channel selection to show content on a specific channel. Recording the channel selections on a representative sample of set top boxes provides data that can be processed to estimate the audience. For such audience estimation, the set top boxes involved in audience estimation send the channel selections upstream on the broadcast network to a central site which combines the data from each set top box. One drawback of conventional forms of set-top-box-based audience monitoring is that audience characterization is typically constrained to signal-based forms of media that flow through the set top box. Consequently, such conventional monitoring often fails to provide a comprehensive view of the wide spectrum of media forms that most audiences encounter. Further, exclusively using set top boxes to characterize an audience's exposure to media does not generally provide a detailed profile of media exposure that segments exposure according to media type, media delivery system, and exposure venue.

The evolution of communication technologies has recently stimulated a proliferation of media types and media settings. In many situations, encounters with advertising messages has reached a level approaching saturation, whereby audiences begin to ignore mass communicated messages and advertisements. In recognition of the dulling effect of too many messages and in an attempt to get their messages to penetrate advertising clutter, advertisers have become interested in selecting specific types of media on a situational basis. For example, a luggage manufacturer may elect to forego advertising on a major television broadcast network in favor of presenting targeted advertisements on televisions stationed in airport lobbies. Likewise, a consulting firm may locate an advertising sign in a corridor of an office tower that potential clients are known to frequent, rather than placing the sign in a mass transit vehicle or advertising in a trade journal.

Oftentimes, an advertising agency may make a recommendation for placement of such an advertisement based on intuition or anecdotal information, rather than on hard data or rigorous analysis. For example, the advertising agency may not have access to a comprehensive profile of the consulting firm's prospective clients, including the various forms of media exposures that those prospects experience on a routine basis. Further, the agency may not have a clear picture of the demographics of the individuals that frequent the corridor or an accurate profile of the various forms of media that those individuals regularly encounter.

While the advertising agency may have access to certain types of media exposure information from commercial sources, such as ratings bureaus, such conventional exposure information is often fragmented, incomplete, or limited in scope. For example, a conventional source of exposure information may offer a demographic profile of an audience that views a specific television channel during a specific time slot. Recording devices coupled to set top boxes in randomly chosen households can acquire viewership information for the audience profile. However, such conventional profiles often fail to provide comprehensive information about the audience and its exposure to media, such as an accounting of the media forms which the audience encounters. That is, conventional technology for audience characterization may narrowly characterize exposure to a specific media type without providing details about exposure to other media types, communicated via multiple delivery system technologies and received in multiple venues. Accordingly, advertisers and their advisors often make advertising decisions based on imperfect or incomplete information. For example, a conventional exposure profile generated solely by set top box monitoring may not include detail about billboard advertisements placed in an office corridor or in a mass transit venue.

Another problem with conventional media exposure technology is a lack of flexibility or adaptability. An advertiser or other party interested in using media for a business purpose often cannot obtain adequate information from conventional media profiles to support an informed decision regarding media selections. Conventional media profiles are often derived from a very limited set of exposure monitoring tools. And, those tools are often misapplied or applied in a one-size-fits-all approach that yields blurred or inaccurate results. That is, conventional technology for obtaining media exposure information generally lacks a capability to select specific or “best-of-breed” monitoring tools for each of multiple exposure situations. For example, conventional ratings approaches often entail attempting to cover too many markets and too many media technologies with a single, ill-suited monitoring technology. Failing to select the proper monitoring technology can result in exposure data that does not properly account for the details, distinctive features, or peculiarities presented by various combinations of media types, media venues, and media delivery systems. Further, conventional media profiles are often produced by monitoring a narrow media segment and then wrongly assuming that the information collected from the monitored segment applies to another, distinct media segment or a broader segment. The underlying assumption can be erroneous. Further, the resulting media profile may provide an estimate about many sectors while not covering any sector with a sufficient level of detail or accuracy.

A party interested in media advertising frequently has a narrow set of sources from which it can acquire exposure data. The limited number of vendors of exposure data sources may compel the party to use exposure data from a single vendor, such as Nielsen Media Research of New York, N.Y., even though that vendor's data may not adequately suit the party's needs. That is, the limited number of commercial sources for exposure data may undesirably constrain an advertiser's choices of exposure profiles. As a result, the advertiser may base an advertising decision on information that lacks adequate specificity to support making the best decision.

Furthermore, ratings for TV media may even be controlled by one company or a very select group of entities that fail to adequately differentiate among the various types of television viewing and among the various locations at which viewing occurs. With limited sources of ratings information and inadequate competition, conventional ratings may lack a suitable level of granularity. Moreover, conventional technologies and approaches often fall short in terms of adequately detailing exposure in narrow categories of venues and in terms of associating delivery technologies with exposures. For example, conventional ratings systems may struggle to provide a sufficient level of discrimination between analog TV and digital cable TV, for example.

Another problem that often occurs with conventional approaches to characterizing audiences is that certain media outlets, media technologies, markets, and population segments often go under represented, perhaps even unrepresented. Thus, consumers in small markets may windup having their voices unheard in terms of their potentially-unique preferences for entertainment and advertising content and for distinctive products and services. For example, the results of characterizing a Boston TV audience may correlate poorly to an audience in Hawaii or in a small town in Montana. To address those representative deficiencies in the art, a need exists for generating a granular or segmented media exposure profile of an audience that provides information with a high level of specificity and that is based on empirical data. Another need exists for aggregating media exposure data from multiple sources and for deriving accurate sector-specific information from the aggregated data. Yet another need exists to increase the number of sources for media exposure information. Still another need exists for increasing the accuracy of media exposure profiles. One more need exists for a technology that can characterize media exposure in small markets, medium or small cities, or in niche situations. A need also exists for a method and system that can open media ratings to more players or to a broader level of competition. Still one more need exists for selecting exposure measurement technologies according to best fit or on a results-oriented basis, rather than with a one-size-fits-all mindset. A capability fulfilling one or more such needs would benefit advertisers, content generators, promoters, and other parties involved in providing content to audiences.

### SUMMARY OF THE INVENTION

The present invention supports characterizing exposure of an audience or a population of people to multiple media types, communicated via multiple delivery systems or technologies to multiple venues or sites. Characterizing the audience's media exposure can comprise measuring, monitoring, or deducing media exposure, obtaining empirical exposure data, or otherwise determining some aspect of the audience's media contacts. Characterizing exposure with specificity can benefit parties, such as advertisers, that use media or mass communications to achieve financial gain or a business objective.

In one aspect of the present invention, a plurality of monitoring instruments, tools, or devices can collect media exposure information about an audience member, for example in a set or group of monitored audience members. That set of monitored audience members can comprise a representative sample of the audience as a whole or can be selected to target a specific audience segment. For each audience member in the monitored set, the monitoring instruments can obtain information about various aspects or facets of media exposures.

For example, a first monitoring instrument can monitor how the audience member encounters or is exposed to television, radio, and print in a home environment. A second monitoring instrument can monitor how the audience member encounters or is exposed to radio and billboards while riding in a car or driving a vehicle. A third monitoring instrument, which could comprise a diary, can monitor media exposures or encounters beyond those that the first and second monitoring instruments detected.

An information processing system, such as a remote data center, can receive the media exposure information from each monitoring instrument for each group member. That system can process the received information to generate a media exposure profile for each monitored group member. Each profile can segment exposure according to delivery system, media type, and venue, for example. The result can be venue and system targeted (“VAST”) ratings.

A deductive capability can help complete each of the group member's profiles, for example, deducing information that was not directly obtained by any of the instruments for a specific individual. That is, each profile can comprise deductive or extrapolated information that augments or better defines the directly monitored information.

The system can process the individual media exposure profiles of the sample group to derive or create an aggregated media exposure profile for the audience as a whole. Processing the sample-group media exposure profiles can comprise information extrapolation, information aggregation, and/or information deduction to yield information that was not directly present in any of the individual sample profiles. That is, the aggregate profile can comprise information generated via deduction, extrapolation, or rule-based processing that augments or better defines information present in the individual sample profiles.

Thus, a first stage of processing can generate a media exposure profile and/or a demographic profile for members of an audience sample based on information that multiple exposure monitoring instruments collect. A second stage of processing can involve applying rules, statistical methods, inference, and/or deduction to the monitored exposure information to generate a more complete or more detailed media exposure picture for each monitored audience member. Aggregating and processing the individual exposure profiles can produce a media exposure profile and/or a demographic profile for the audience sample and/or for the audience as a whole.

The discussion of characterizing media exposure presented in this summary is for illustrative purposes only. Various aspects of the present invention may be more clearly understood and appreciated from a review of the following detailed description of the disclosed embodiments and by reference to the drawings and the claims that follow. Moreover, other aspects, systems, methods, features, advantages, and objects of the present invention will become apparent to one with skill in the art upon examination of the following drawings and detailed description. It is intended that all such aspects, systems, methods, features, advantages, and objects are to be included within this description, are to be within the scope of the present invention, and are to be protected by the accompanying claims.

### BRIEF DESCRIPTION OF THE DRAWINGS

FIGS. 1A, B, and C, collectively referred to as FIG. 1, are illustrations showing an exemplary media exposure profile for an audience segmented by delivery system, media type, and venue according to an embodiment of the present invention.

FIG. 2 is functional block diagram of an exemplary system for generating a media exposure profile for an audience according to an embodiment of the present invention.

FIG. 3 is functional block diagram of an exemplary system for monitoring a audience member's exposure to media in an in-home environment according to an embodiment of the present invention.

FIG. 4 is functional block diagram of an exemplary system for monitoring an audience member's exposure to media in a vehicle according to an embodiment of the present invention.

FIG. 5 is functional block diagram of an exemplary system for monitoring an audience member's exposure to media according to an embodiment of the present invention.

FIG. 6 is a flow diagram illustrating an exemplary process for characterizing an audience's exposure to media according to an embodiment of the present invention.

FIGS. 7A and 7B, collectively referred to as FIG. 7, are a flow diagram illustrating an exemplary process for generating a profile of an audience's exposure to media according to an embodiment of the present invention.

FIGS. 8A and 8B, collectively referred to as FIG. 8, are a flow diagram illustrating an exemplary process for obtaining an exposure profile and making an advertising decision based on that profile according to an embodiment of the present invention.

Many aspects of the invention can be better understood with reference to the above drawings. The components in the drawings are not necessarily to scale, emphasis instead being placed upon clearly illustrating the principles of exemplary embodiments of the present invention. Moreover, in the drawings, reference numerals designate corresponding, but not necessarily identical, parts throughout the different views.

### DETAILED DESCRIPTION OF THE EXEMPLARY EMBODIMENTS

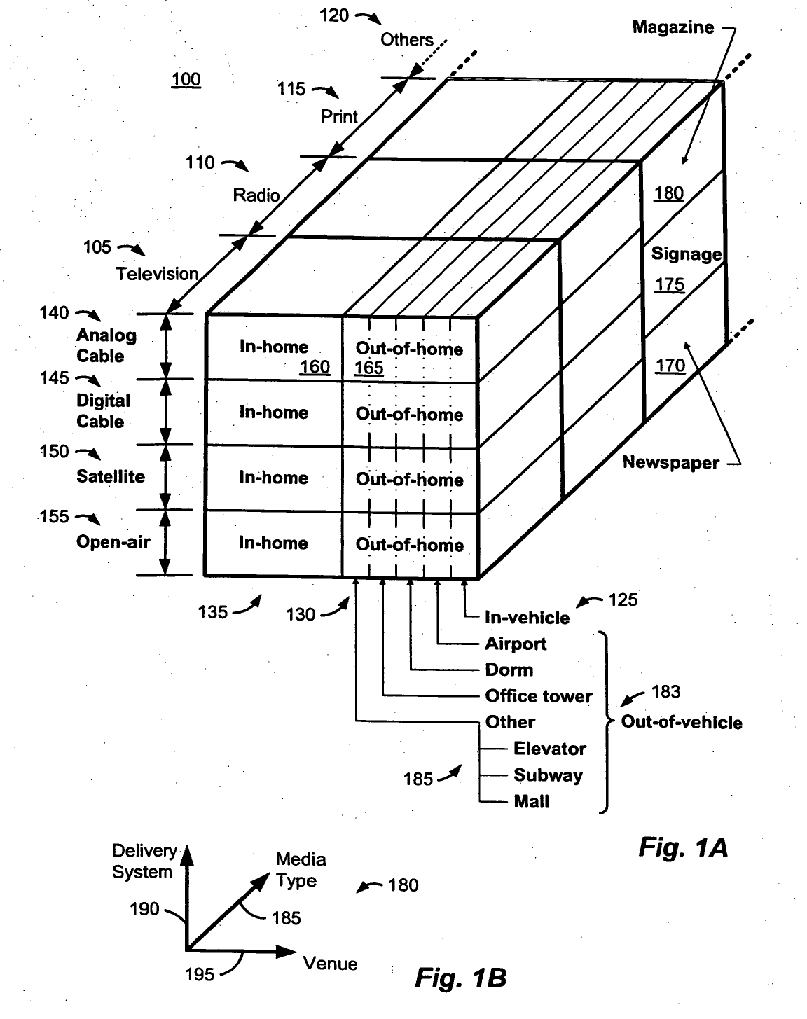

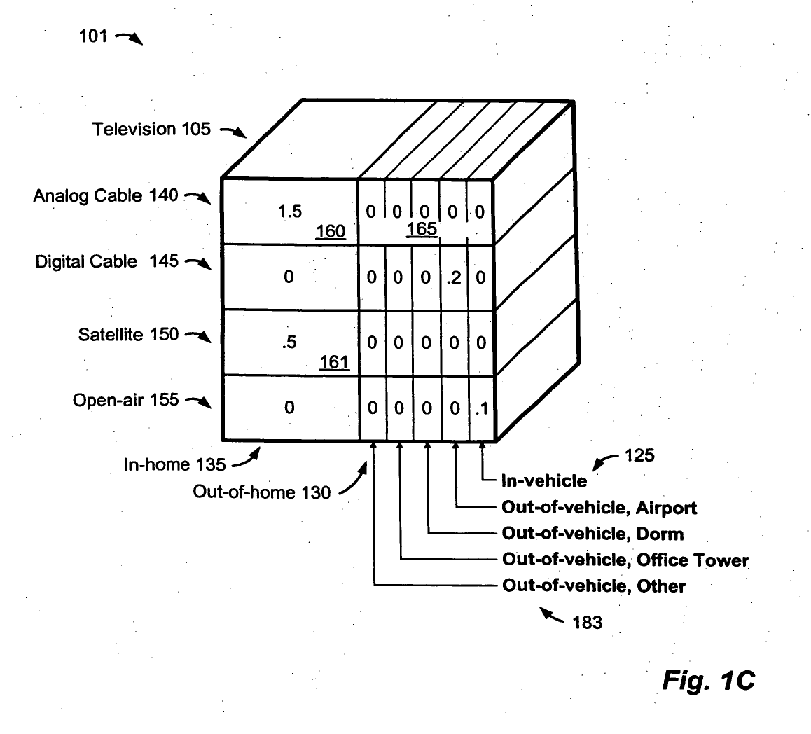

Exemplary embodiments of the present invention can obtain media exposure information and process that information to generate a detailed or comprehensive media exposure profile for an audience. That generated profile can provide exposure detail regarding plural venues, plural media types, and plural media systems. A method and system for characterizing an audience to generate a detailed media exposure profile will now be described more fully hereinafter with reference to FIGS. 1-8, which show representative embodiments of the invention.

In one exemplary embodiment of the present invention, a method and system breaks down media ratings into venue and system specific targets. Breaking down ratings into venues and systems can encourage new ratings players and the adoption of new technologies for monitoring exposure and characterizing audiences. For example, using custom venue and systems specific measurement devices facilitates detailed or granularity ratings. A capability to aggregate those details can deliver overall ratings.

In other words, an exemplary embodiment of the present invention monitors media exposure with a high level of detail, thereby providing focused information about specific markets, people, locations of media exposure, media types, and media delivery technologies, as well as other points of interest. Further, the embodiment can aggregate those details to provide a bigger picture or profile that describes broader classes of markets, people, exposure location, media types, or media delivery technologies. And, users of such a profile can drill down to essentially any level of detail they may find useful.

One exemplary embodiment of the present invention, supports cross media measurements. For example, a single monitoring device can accurately monitor multiple media types in a single venue. As will be discussed in further detail below, one instrument can determine whether a member of an audience is watching digital TV, listening to digital radio, or doing neither, for example.

In one exemplary embodiment of the present invention, an entity (for example a business) aggregates media exposure measurements or ratings from multiple sources. The aggregator may purchase available ratings for cable TV from an information vendor, obtain public data about highway traffic that is indicative of billboard viewing, and contract with someone to conduct a survey of magazine viewing in dentist offices, for example. To fill in gaps, the aggregator may deploy its own monitoring systems in selected venues, or create targeted monitoring instruments to gauge exposure to a specific marketing program or advertising campaign. In other words, the aggregator can contract with the best-suited vendors and can undertake precision monitoring, thereby providing an aggregated approach to obtaining ratings that is sound and detailed.

In one exemplary embodiment of the present invention, an exposure monitoring instrument can focus on a venue (for example in-car) or a media system (for example TV) rather than emphasizing a specific type of audience or a specific class of people. Such a monitoring approach can enhance the accuracy of the exposure and ratings results.

One exemplary embodiment of the present invention involves promoting competition among sources of ratings information. A method can proceed by dividing a media into venue and/or systems and letting competitive forces dictate the best way of measuring media within a specific system or within a targeted venue. This approach can help differentiate between TV consumption in a sports bar and TV consumption in a home, while providing essentially the best monitoring technologies in both settings.

In other words, rating exposure to a media can comprise: segmenting the media (for example according to venue and each delivery system type); dictating that each sector be measured in an optimal, best, near-best, or solid manner (for example via encouraging competition); opening the measurement activities to a competitive environment; and aggregating the results. The net result can be measurements or rating results that are accurate and unbiased.

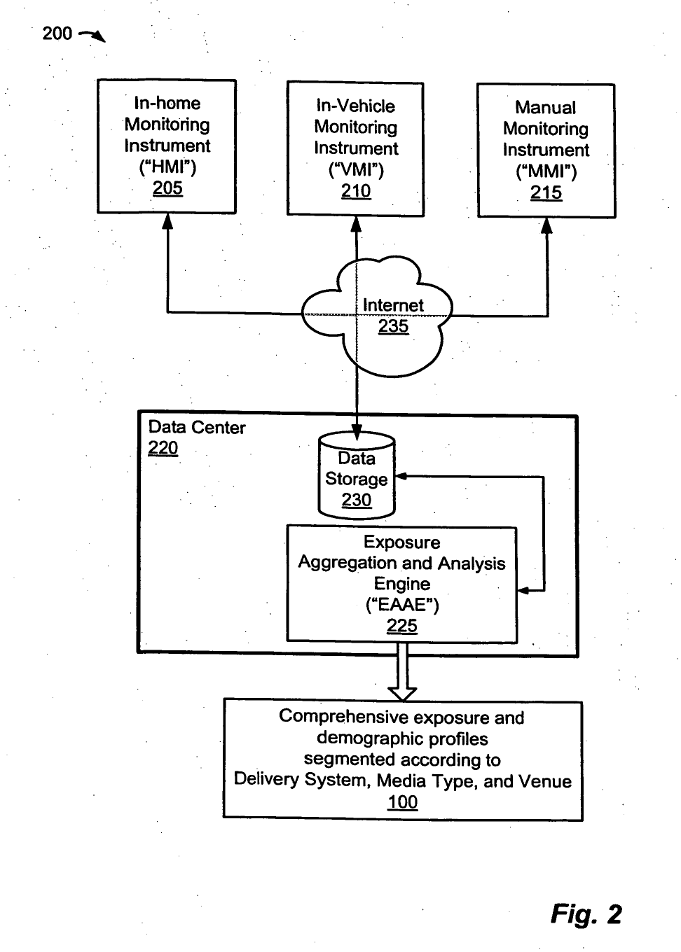

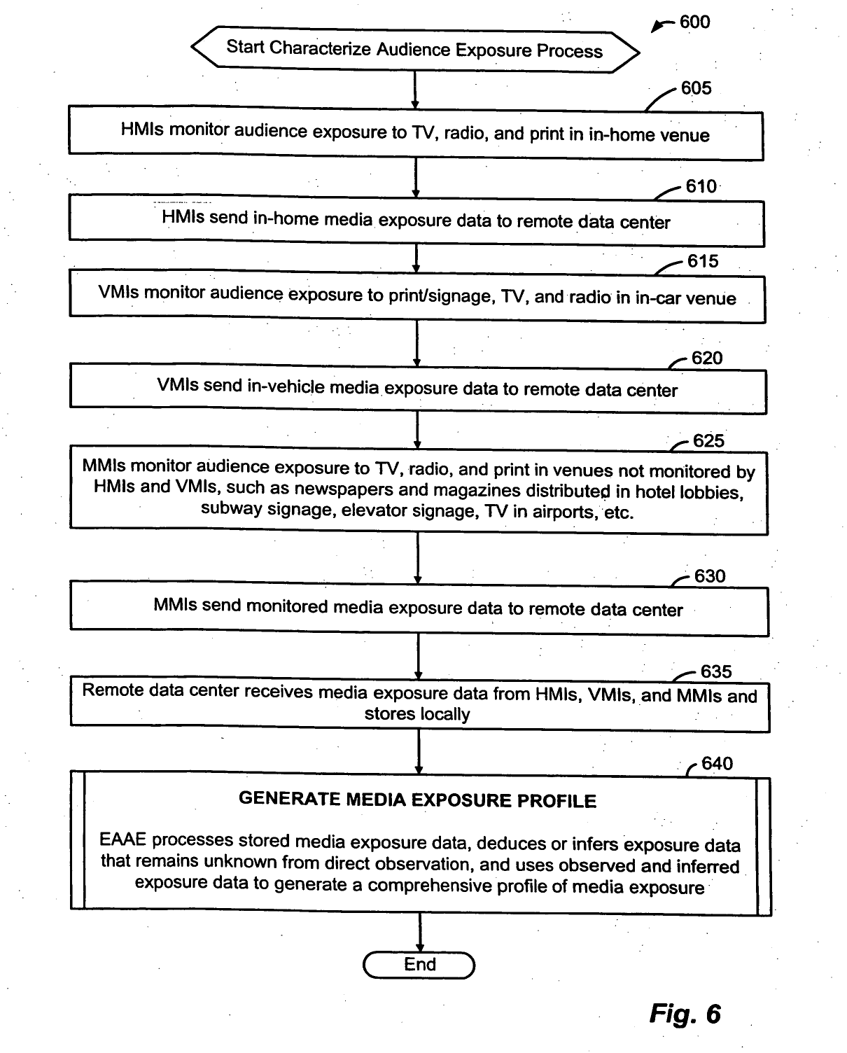

Additional information regarding the aforementioned exemplary embodiments as well as regarding other exemplary embodiments follows, with reference to the appended figures. FIG. 1 provides a three-dimensional representation of an exemplary media exposure profile. FIGS. 2-5 provide system- and component-level illustrations of an exemplary system for monitoring media exposure and generating a media exposure profile. FIGS. 6, 7, and 8 present flowcharts of exemplary processes related to monitoring media exposure, generating a media exposure profile, and placing an advertisement.

The invention can be embodied in many different forms and should not be construed as limited to the embodiments set forth herein; rather, these embodiments are provided so that this disclosure will be thorough and complete, and will fully convey the scope of the invention to those having ordinary skill in the art. Furthermore, all “examples” given herein are intended to be non-limiting, and among others supported by exemplary embodiments of the present invention.

Turning now to FIGS. 1A-C, these figures illustrate a media exposure profile 100 for an audience segmented by delivery system 190, media type 185, and venue 195 in accordance with an exemplary embodiment of the present invention. The media exposure profile 100 provides an ordered arrangement of media sectors, wherein at least one media delivery system coordinate, at least one media type coordinate, and at least one venue coordinate collectively specify each media sector. In other words, each illustrated media sector is a crossing of delivery system, media type, and venue.

In some instances, a media sector may have exactly two dimensions. For example, the television media type 105 can be sectored according to delivery type 140, 145, 150, 155 and/or venue 125, 130, 135, 183, 185.

The media exposure profile 100 can be considered a system for or a presentation of VAST ratings. Moreover, the illustrated profile 100 exemplifies providing media ratings in a multidimensional format, whereby VAST ratings overlay VAST sectors.

Referring to FIGS. 1A and 1B, the media exposure profile 100 can describe a single member of an audience, who may be on individual in a sample taken from a broader audience. For example, a group of audience members can be selected for targeted exposure profiling or as part of a random sample that supports characterizing a broader audience. The media exposure profile 100 can also describe the sample group or the audience as a whole.

The media exposure profile 100 presents media exposure data in three exemplary dimensions 185, 190, 195 thus facilitating a three-dimensional visualization of media sectors, as shown in FIG. 1A. Presenting a media exposure profile 100 in a three-dimensional coordinate system 180 can help humans relate to and work with the profile's data to facilitate making fruitful advertising decisions. It will be appreciated that other exemplary media exposure profiles can generally have an arbitrary number of dimensions, such as two, five, ten, or twenty. One or more such dimensions could provide demographic information about an audience, for example. Nevertheless, in many circumstances, it will be useful to collapse or compress a profile that comprises four or more dimensional representations into a more manageable number, such as two or three, that a human mind can readily visualize.

The depth dimension 185 (“into” the page of FIG. 1A) presents types of media. That is, the depth axis 185 shows categories, classes, or sectors of communications that have multiple intended recipients. The media exposure profile 100 shows television 105, radio 110, and print 115 as exemplary media types 185, that may also be referred to as media type sectors. The media exposure profile 100 can also include other media type categories 120 that may be pertinent to a particular situation or a particular user. For example, a consulting firm seeking new clients may have interest in using the Internet or meetings, such as professional society functions, seminars, and tradeshows, to reach those clients. Thus, the profile 100 could be expanded to include Internet and meetings on the media-type axis 185.

The vertical dimension 190 specifies delivery system 190 or the systems and technologies that can underlie each media type 185. That is, the delivery system axis 190 describes mass communication vehicles or represents base facilities for conveying messages to multiple recipients.

The exemplary media exposure profile 100 shows four delivery systems 140, 145, 150, 155 for each of television 105 and radio 110. That is, television media 105 and radio media 110 can be delivered by at least four types of technologies that the media exposure profile 100 categorizes. Each of the delivery systems 140, 145, 150, 155 can specify a media sector or a facet of a media sector.

The open-air delivery system 155 refers to antenna-based delivery of radio and television signals over an air medium. An audience member may have a television with “rabbit ear” antennas that receives local programming broadcast from a nearby television station antenna, for example.

The satellite delivery system category 150 of the television media type 105 represents exposure to televised content received via satellite. Whereas open-air programming might be limited to a handful of channels, a satellite system could offer an audience member more than one-hundred programming choices, for example.

A particular audience member may have an open-air television in a home basement, while a satellite-based television in that home's family room provides a wider selection of channels. Thus, a single audience member may regularly have exposures to television media 105 involving multiple delivery systems 190.

The analog and digital cable categories 140, 145 of television media 105 respectively describe media exposures that arrived to an audience member over a television cable system via analog and digital signals.

Whereas television media 105 and radio media 110 can be delivered via open-air 155, satellite 150, digital cable 145, and analog cable 140, those delivery system categories 140, 145, 150, 155 may not apply to print media 115. The print media category 115 can describe an audience member's exposure to permanent or semi-permanent lettering, symbols, graphics, pictures, etc. that are fixed or attached to a physical surface.

The media exposure profile 100 of FIG. 1 illustrates print media 115 with three exemplary delivery system categories 170, 175, 180, namely newspaper 170, signage 175, and magazine 180. Thus, the profile 100 can provide a characterization or statistical record of exposures to printed messages communicated via newspaper 170, signage 175, and magazines 180. The signage category 175 can include billboards, posters, placards, promotional signs, etc.

The horizontal axis 195 of the exemplary media exposure profile 100 presents exposure categorization according to venues or sites at which exposures occurred. That is, the horizontal axis 195 can specify one or more media sectors.

The in-home venue category 135 and the out-of-home venue category 130 respectively describe exposures that occurred while the audience member was inside and outside his or her residence, home, or house. The out-of-home category 130 is further segmented into an in-vehicle category 125 and an out-of-vehicle category 183. The out-of-vehicle category 183 comprises the categories: airport; dorm; office tower; and other. The ‘other’ venue category 185 is further segmented into elevator, subway, and shopping mall categories. Categories can generally be partitioned into an arbitrary number of subcategories, according to a desired level of exposure specificity.

The media exposure profile 100 illustrates exemplary venue categories 130, 135 that are applicable to television media 105, radio media 110, and print media 115, thereby reflecting consumption of or exposure to those media types 105, 110, 115 in in-home and out-of-home environments 130, 135. The cells 160 and 165 provide exposure data for analog cable television delivered respectively at in an in-home venue 135 or an out-of-home venue 130. Each of those cells 160, 165 can be considered a media sector.

The media exposure profile 100 further provides common venue classifications or sectors for the print media category 115 and the television and radio media categories 105, 110. Thus, the media exposure profile 100 can provide an accounting of an audience member picking up a newspaper or magazine at home, in an airport, or in a car or watching open-air television in any of those three venues. Furthermore, individual categories can reflect exposure in a hotel lobby that has a wireless radio, a satellite-based television, or a cable television as well as various forms of print advertising.

In some situations, certain venue categories may not apply to every media type 185 or every delivery system 190. For example, a billboard would not likely reach an audience member at home.

The profile 100 can result from or can represent VAST ratings that may result from having one or more ratings collection points that are focused upon a specific delivery system, such as television 105, or upon specific sectors of interest. In many circumstances, as discussed in further detail below, a single collection point can capture exposure information about multiple sectors. This capability can be viewed as cross-media monitoring, which in many situations can be efficient or cost effective.

For example and as described below, an appropriately outfitted remote control can monitor print, radio, and television exposure or consumption in an in-home venue 135. Further, appropriately outfitted remote controls could breakdown television viewing according to analog cable 140, digital cable 145, satellite 150, and open-air 155, or according to some other sectors or categories of interest.

Referring now to FIG. 1C, this figure illustrates a representative portion 101 of the media exposure profile 100 populated with exemplary data. That is, the illustrated cells 101 can represent an exemplary portion of a more comprehensive exposure profile 100. In an alternative embodiment, the cells 101 of FIG. 1C provide a full media exposure profile that may interest a business focused exclusively on television-based advertising, for example. Moreover, each of the cells 101 can comprise a sector, wherein two coordinates define each cell 101. For example, analog cable delivery type 140 and in-home venue 135 can define or specify the cell 160.

The data of the cell 160 indicates that an audience member was exposed to or watched 1.5 hours of analog cable television in his or her home. In other words, the media sector of home-based analog cable television yielded 1.5 hours of media exposure. That exposure data could reflect a daily exposure or an exposure over some other period of time. Thus, the audience member may have watched 1.5 hours on a specific day or alternatively on typical day, as averaged over several weeks.

The cell 161 indicates that the audience member was exposed to 0.5 hours of in-home satellite television for the reported period. The analog cable, out-of-home cells 165 show no exposure to analog cable television 140 in an out-of-home venue 130. The profile 101 also reports that during the reporting time period, the audience member was exposed to 0.2 hours of digital cable media 145 in an out-of-vehicle venue 183, specifically an airport. Further, the audience member watched 0.1 hours of open-air television while riding in a vehicle, for example as a passenger of a car with a rear-seat television.

Turning now to FIG. 2, this figure illustrates a functional block diagram of a system 200 for generating a media exposure profile 100 for an audience in accordance with an exemplary embodiment of the present invention. The system 200 can acquire empirical exposure data and can supplement that acquired data with inferred or computed data or with data obtained from commercial sources. Using empirical and supplemental data, the system 200 can generate the media exposure profile 100 and populate it with data to describe an individual audience member, a selected or targeted subset of an audience, or an audience at-large. Moreover, the system 200 is an example of a system that can produce VAST ratings and VAST profiles based on VAST sectors.

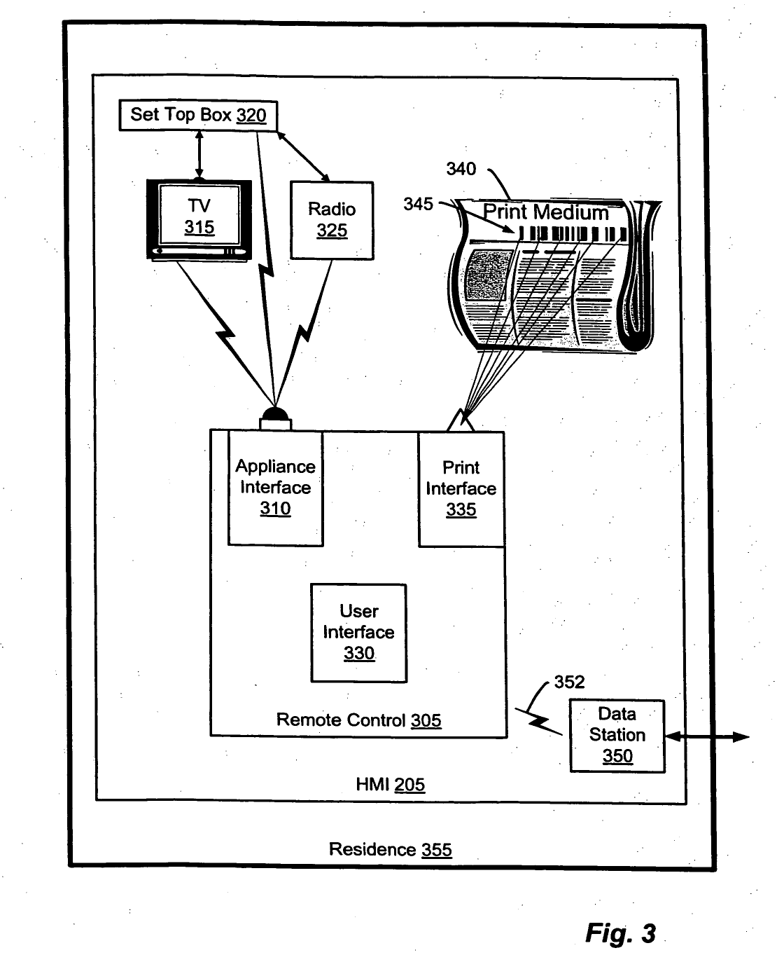

The system 200 comprises three exemplary monitoring instruments 205, 210, 215 that obtain exposure data regarding one or more audience members. These three instruments 205, 210, 215 acquire venue-specific exposure data that provides the basis for generating the media exposure profile 100. FIGS. 3, 4, and 5, discussed below, respectively illustrate exemplary embodiments of those instruments 205, 210, 215.

The term “monitoring instrument” or “instrument,” as used herein, refers to something, such as a system, device, method, process, etc., that obtains, identifies, or receives data about the exposure of one or more persons to one or more communications or messages that are intended for receipt by a plurality of persons. The exposure might comprise an inadvertent or deliberate contact of an audience member with a message delivered via television, radio, print, the Internet, a meeting, etc. A monitoring instrument could be a survey, a set top box that monitors channel selections, a remote control that tracks user interactions with a media appliance such as a television or a radio, a paper-based diary or log of media exposure that a person manually completes, a computer-based or electronic survey, a vehicle-mounted system that detects channel settings of an in-vehicle radio, a system that records a vehicle's location and determines instances of driving by known sign or billboard locations, a person that observes individuals in a public place as they encounter media and who takes notes about his or her observations, a method for downloading demographic or viewership data from an Internet website, a click-monitoring software program or cookie that records and analyzes visits to Internet sites, or a process for obtaining industry data or statistics from a trade organization or commercial source, to name a few examples.

In one exemplary embodiment, a monitoring instrument is self reporting. For example the monitoring instrument might autonomously collect exposure data and transmit that collected data to a remote data repository or a central site. Internal software can implement self-reporting logic. The monitoring instrument can report in response to an occurrence of a specified event or to some stimulus. As an alternative to self reporting, the monitoring instrument can report in response to a request from the remote data repository or some other control signal. As another alternative, a remote data collection facility can pull monitored data from the monitoring instrument.

The in-home monitoring instrument (“HMI”) 205 acquires or obtains data about the audience member's media exposure in the in-home venue 135. The HMI 205 acquires statistics or empirical data about television, radio, and print exposure while the audience member is in his or her residence, home, or house. In one exemplary embodiment, the HMI 205 obtains Internet exposure data within the home venue 135.

The in-vehicle monitoring instrument (“VMI”) 210 obtains media exposure data about media exposures that occur while the audience member is driving or riding in a vehicle, such as a car or truck. The VMI 210 can identify contacts that the audience member has had with specific roadside signage 175, such as billboards, and can further monitor in-car radio and in-car television media exposure.

The manual monitoring instrument (“MMI”) 215 obtains media exposure data that the HMI 205 and the VMI 210 may not be in a position to obtain. Whereas the HMI 205 and the VMI 210 may obtain empirical data regarding exposures that occur under relatively predictable circumstances, the MMI 215 can be a more general tool that addresses a wider variety of exposure circumstances. That is, the MMI 215 can be a catchall for collecting media exposure data.

The system 200 can further comprise other monitoring instruments not illustrated in FIG. 2. For example, in one exemplary embodiment, the system 200 comprises a software module that monitors and records the audience member's visits to Internet sites. That module can be a monitoring instrument. As another example, an observer, functioning as a monitoring instrument, can monitor an audience walking in a shopping mall to obtain empirical data about how many shoppers are exposed to a sign in the shopping mall. As yet another example, an instrument can comprise an analyst purchasing airline statistics to estimate audience exposure to a satellite television in an airport waiting lobby.

A monitoring instrument can even be embedded in a consumer electronic device or a personal media player. For example, a battery-operated personal radio that an individual carries or wears can comprise a capability to identify its user and the content that it is playing and to transmit media exposure information to a remote site.

A chipset embedded within the radio identifies the content that the personal radio is playing. An integral radio frequency identification (“RFID”) system reads RFID tags to identify audience members. Each audience member that is a participant in a media survey wears a unique RFID tag, for example in a purse, wallet, or bracelet, that the radio's RFID reader reads. A wireless transmitter within the personal radio sends the identity of the content and the identity of the user from the radio to a remote data recording and analysis site. In this manner, the personal radio can track the radio-based media exposures of each member in an audience sample and can correlate those tracked exposures to each respective audience member.

The system 200 can also comprise a set of monitoring instruments that are selected according to “best-of-breed” technologies that are suited to a particular advertising problem or situation. Thus, a business interested in evaluating advertising alternatives can select a specific set of monitoring instruments that are well suited to obtaining sector-specific media exposure information.

With the appropriate selection of monitoring instruments, the obtained exposure information can be detailed so that the manager of the business can “drill down” on sector options. For example, the advertiser can expand a sector of interest into multiple sectors, each of finer detail. The expanded sectors can have hierarchical relationships among one another. That is, the present invention supports splitting a media sector into a number of sector levels, wherein each level comprises sub-sectors, and further supports assigning empirical exposure data to each sub-sector at each level.

Moreover, the present invention can support providing more accurate, more inclusive readings within the media ratings industry by infusing competition and by breaking the industry into sectors that could be differentiated using sector-specific and media-specific technologies. In an exemplary embodiment, this benefit may be achieved without necessarily dictating any specific technology for monitoring media exposure. Rather, the VAST methodology can comprise embracing competition and capitalism as a non-monopolistic way of generating ratings that have enhanced accuracy. A methodology based on free enterprise can avoid the pitfalls of monopoly.

That methodology can comprise segmenting a media type 105, 110, 115, 120 into venues 130, 135, 125, 183 and delivery systems 140, 145, 150, 155 and then measuring each venue and delivery system 130, 135, 125, 183, 140, 145, 150, 155 through a competitive process in which an entity aggregates information from multiple sources. The aggregator typically has latitude to select the best monitoring technologies and the best sources as the aggregator sees fit. Further, the aggregator can elect to conduct supplemental exposure monitoring as deemed appropriate or to fill any gaps.

The aggregator's selections will typically lead to exposure data, ratings, and profiles that have enhanced levels of accuracy and granularity and that are generally free from bias or partiality. In such a competitive environment, a single media marketplace, for example in Hawaii, could be monitored from multiple angles and by multiple entities, resulting in robust results.

For example, an entity might want to determine the best way to measure how cable-delivered radio is being consumed in in-home venues 135. If the technology that the entity has already deployed for monitoring cable-delivered TV in the in-home venue 135 is also suited for monitoring cable-delivered radio, then the entity has a cross-media solution that addresses both sectors. In this instance, the result is more accurate and more conclusive means of measuring media consumption based, not necessarily based on market and not necessarily based on an individual, but rather based on a venue 195, a media type 185, or a delivery system 190.

The monitoring instruments 205, 210, 215 of the system 200 connect to the data center 220 via a communication network that can be the Internet 235 or some other communication system, network, or facility. Networks that provide connectivity between the monitoring instruments 205, 210, 215 and the data center 220 can comprise a public network, a private network, a cable network, an intranet, a local area network (“LAN”), a satellite network, a cellular network or another wireless network, the public switched telephone network (“PSTN”), a distributed computing network, an Internet protocol (“IP”) network, a wide area network (“WAN”), a personal video recorder network, a regional network, a metropolitan area network (“MAN”), and/or a packet switched network, to name a few examples.

In place of the Internet 235, the system 200 can also comprise a communication link that sends reporting data from the monitoring instruments 205, 210, 215 to the data center 220 using a physical medium rather than by modulated signals. For example, a person may manually tabulate data from the monitoring instruments 205, 210, 215 on paper and send that paper to the data center 220 via postal service physical mail delivery. A person could even carry data from one or more monitoring instruments 205, 210, 215 to the data center 220 or some other central location or processing facility.

Those experienced in the art will further recognize that the system 200 can comprise any of numerous communications networks and systems (including presently available systems and future systems) and that such networks and systems may be substituted or interchanged with the Internet 235.

While FIG. 2 shows the Internet 235 connecting three monitoring instruments 205, 210, 215 to the data center, the system 200 can have many of sets of those instruments 205, 210, 215 connected in a similar fashion. For example, each audience member in a sample or large group or audience members can undergo monitoring by a set of monitoring instruments 205, 210, 215. Each audience member's respective set of monitoring instruments 205, 210, 215 can feed monitored data to the data center 220 via the Internet 235.

The monitored audience members, and/or their respective residences, can be geographically dispersed or concentrated in a locale, such as a town, neighborhood, or community. In one exemplary embodiment of the present invention, the monitored audience members are geographically dispersed but share a common demographic characteristic, such as a socioeconomic standard. The present invention is not limited to a specific number of audience members that are monitored or a specific number of sets of monitoring instruments 205, 210, 215 but rather can support arbitrary numbers. The system 200 can comprise one, several, several hundred, or many thousands of sets of monitoring instruments 205, 210, 215 that collect media exposure data from respective audience members and report that data to a central site, such as the data center 220.

The monitoring instruments 205, 210, 215 can be coupled to the Internet 235 through a hardwire connection, a wireless connection, or another suitable facility to transfer signals. A hardwire connection can comprise coaxial cable, a fiber optic link, or another suitable connection. A wireless connection can comprise a satellite link, a radio frequency signal path, or another suitable connection.

In one exemplary embodiment, a client computer (not shown in FIG. 2) aggregates exposure data from the monitoring instruments 205, 210, 215 associated with each monitored audience member and performs preliminary processing. That is, each monitored audience member can have an assigned client computer that collects exposure data from that audience member's monitoring instruments 205, 210, 215. The client computer can compress and format that exposure data for transmission to the data center 220 via the Internet 235 continually or on an event-driven or time-driven basis, for example.

The data center 220 typically comprises a computing facility with an Internet connection. For example, the data center 220 can be a building with a bank of personal computers, connected together via a LAN, or a more powerful mainframe computer. The data center 220 can use its computing resources to process and analyze exposure data from the monitoring instruments 205, 210, 215. The data center 220 can also comprise a staff of people that operate its computers, perform various functions, and make decisions as appropriate.

The data center 220 comprises data storage 230 for storing exposure data received from the monitoring instruments 205, 210, 215. The data storage 230 can comprise a hard drive, a magnetic tape, optical media, random access memory (“RAM”), dynamic memory, magnetic media, a server, or a storage computer (not an exhaustive list). Thus, the data storage 230, maintains a record for each monitored audience member in a sample set that is representative of a larger audience, an entire audience, or some segment of an audience. Such a segment of an audience could be selected according to a demographic or a profile of particular interest to an advertiser, content provider, content creator, or other party.

In one exemplary embodiment of the present invention, the data storage's record for each audience member does not identify or name the audience member but nevertheless may contain an accurate demographic profile for the audience member. In other words, each audience member can remain anonymous while the data storage 230 contains comprehensive and accurate data about each audience member's media exposure and demographics. The demographic profile of each audience member can include information such as level of income, age, occupation, sex, recreational interests, purchasing habits, family size, average monthly expenditures, languages, debt, age, educational background, etc.

The data center 220 also comprises an exposure aggregation and analysis engine (“EAAE”) 225 that processes monitored exposure data to generate the media exposure profile 100. That is, the EAAE 225 outputs a comprehensive accounting of audience exposures segmented according to media type 185, delivery system 190, and venue 195 or another classification system, as appropriate.

In one exemplary embodiment, the EAAE 225 can also output demographic data as part of the media exposure profile 100, for example as a fourth dimension or as appended data. Such demographic data can comprise derived information; information acquired directly from the monitored audience members; information obtained from a government census, a commercial source that provides demographic estimates, a trade or industry database, an employer, a tax databank, or a municipal or mortgage record; etc. As discussed above, in one exemplary embodiment, demographic data that describes each monitored audience member can provide an accurate description of an audience member or a group of audience members while maintaining the anonymity of each audience member.

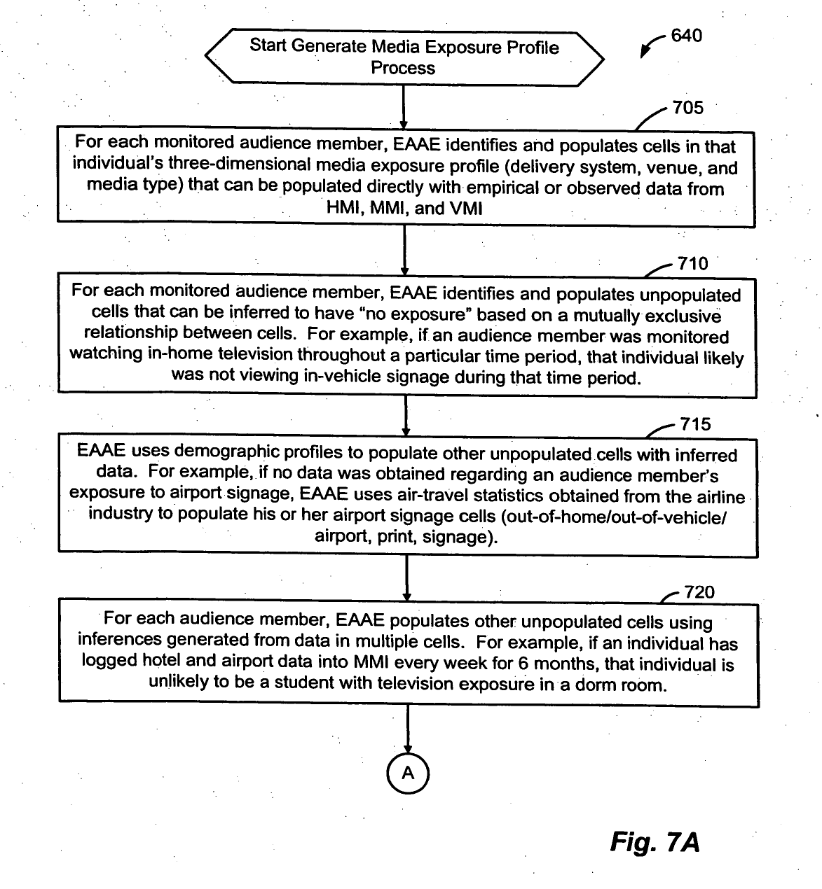

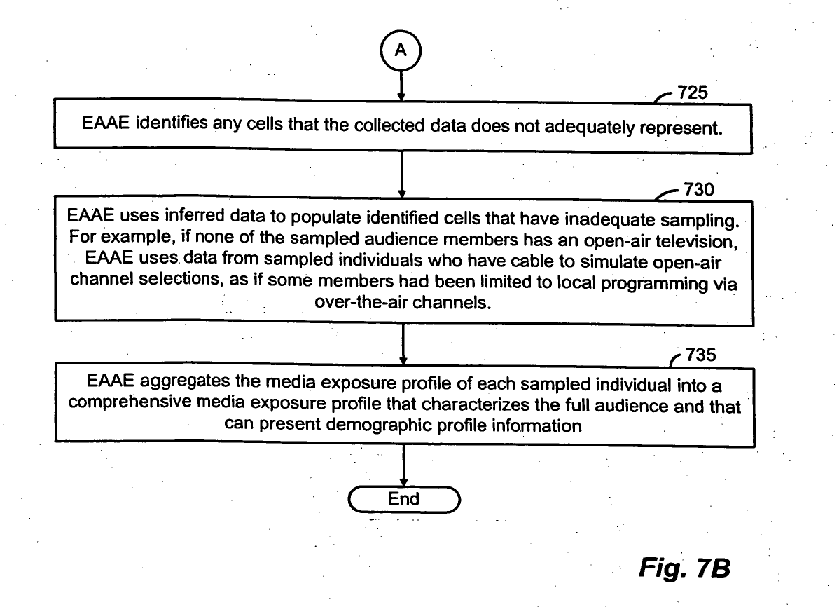

The EAAE 225 is typically a software module but can comprise one or more computer programs, computer-implemented methods or steps, or a combination of manual and automatic actions and computer logic. Further, the EAAE 225 can comprise one or more program modules that include routines, sub-routines, programs, objects, components, data structures, etc., which perform particular tasks or implement particular abstract data types. As will be discussed in further detail below with reference to FIGS. 6 and 7, the EAAE 225 can implement processing based on rules, logical decisions, statistical processing, data processing, deduction, inference, or learning.

Moreover, those skilled in the art will appreciate that the present invention and/or the functions of the EAAE 225 may be implemented in a variety of computer system configurations, including handheld devices, multiprocessor systems, microprocessor based or programmable consumer electronics, network personal computers, minicomputers, mainframe computers, and the like. The invention may also be practiced in distributed computing environments, where tasks are performed by remote processing devices that are linked through a communications network. In a distributed computing environment, program modules may be located in both local and remote memory storage devices.

The EAAE 225 can comprise any of the technologies disclosed in U.S. Patent Application Publication Number 2003/0172374 to Vinson et al., which is entitled “Content Reaction Display,” the entire contents of which are hereby incorporated as Appendix B and by reference. Thus, an exemplary embodiment of the data center 220 can comprise one or more of the hardware elements, software routines, methods, systems, or network architectures disclosed in U.S. Patent Application Publication Number 2003/0172374. Further, the disclosure and teaching of that patent reference can support making and using exemplary embodiments of the present invention, including the EAAE 225 of the system 200, as illustrated in FIG. 2.

Turning now to FIG. 3, this figure illustrates a functional block diagram of a system 205 for monitoring an audience member's exposure to media in an in-home environment in accordance with an exemplary embodiment of the present invention. That system 205 can be an exemplary embodiment of the HMI 205 of the system 200 illustrated in FIG. 2, and will be described as such.

The HMI 205 monitors media exposures in a residence 335 of an audience member. More specifically, the exemplary HMI 205 can monitor exposures associated with a television 315, a radio 325, and an item 340 comprising print media, specifically a newspaper 340. That is, the HMI 205 has an operability to monitor television media 105, radio media 110, and print media 115 for inclusion in the respective cells 105, 110, 115 of the media exposure profile 100.

The audience member uses a remote control 305, typically a handheld device, to control various aspects of the television 315 and its associated set top box 320 and a radio 325. The remote control 305 can be a universal remote control with an operability to interface with and control a range of media appliances in the residence 335. For example, the remote control 305 can have a capability for interacting with Internet-based content, content delivered via the PSTN, a VCR that plays rented tapes comprising entertainment and commercials, a DVD system that plays optically recorded disks comprising promotional and entertainment content, etc.

The remote control 305 can also be an interactive remote control that supports interacting with content, responding to surveys, placing orders for products advertised on the television 315 or discussed in a radio program, etc. The remote control 305 can further have a graphical or textual display, which may be part of its user interface 330, for presenting questions to its audience member user. Those questions can concern specific advertising content shown on the television 315 or on the remote control itself. The effect of such questions can be to stimulate the audience member's attentiveness or to induce a response to that advertising content.

The set top box 320 provides the television 315 with connectivity to a network (not shown on FIG. 3) that delivers or broadcasts television signals and radio signals, each carrying content. That network can comprise an analog cable system, a digital cable system, a satellite-based system, and/or an open-air/antenna-based network. That is, the set top box 320 can provide television media 105 and radio media 110 in the delivery system types of analog cable 140, digital cable 145, satellite 150, and open-air 155, per the media exposure profile 100. In the case of providing open-air media 110, the set top box 320 can be configured to emulate the functionality of a tradition “rabbit ear” television system. Thus, the set top box 320 has a capability to track the audience member's television and radio selections according to the respective cells 140, 145, 150, 155 of the media exposure profile 100.

In one exemplary embodiment, the remote control 305 is operative to interact with remotely accessed video content, to place purchase orders related to the video content, or to enter responses to queries presented on an integral display or on the television 315 about that video content.

Thus, the audience member can select an on-demand video stored on a remote video-on-demand (“VOD”) server (not shown on FIG. 3) by making a selection entry into the remote control 305. In response to receiving the consumer's video selection entry, the set top box 320 sends a message, prompt, or signal via a VOD network (not shown on FIG. 3) to the VOD server. In receipt of that signal, the VOD server makes prerecorded video content available to the set top box 320. The set top box 320 commences downloading and storing or buffering that content for presentation on the television 315. Thus, the set top box 320 can create a record of media exposures involving VOD services. In one exemplary embodiment, the media exposure profile 100 has one or more cells that track such VOD media exposures.

The set top box 320 can be housed separately from the television 315, as a unit placed near, beside, or on top of the television 315. Alternatively, the set top box 320 can be an integral unit, subsystem, or module of the television 315, for example circuitry, software, and components that are internal to the television 315. In one exemplary embodiment, the set top box 320 comprises functionality dispersed among numerous components and subsystems of the television 315. Thus, in certain exemplary embodiments, the set top box 315 is not a single discrete element. The set top box 320 can likewise be connected to, be associated with, or be a part of the radio 325.

The remote control 205 comprises a user interface 330 through which the audience member inputs content and/or media type selections. Those media type selections and channel selections correspond to and represent media exposure data.

The user interface 330 can comprise buttons, a key entry pad, an alphanumeric display, and/or a graphical display, for example. In response to the audience member's input, the appliance interface 310 outputs wireless signals, typically infrared or radio frequency (“RF”), in appropriate formats for interfacing with and controlling various media appliances 315, 320, 325 present in the residence 355.

The remote control 305 has an RF link 253 to a data station 350, which may be a multifunction home computer, a dedicated client computer, or another type of communication device, connected to the Internet 235. Media exposure data, in the form of the audience member's content selections and media delivery type selections, transmits over that data link 352 for receipt by the data station 350. The data station 350 forwards that media exposure data to the data center 220 for use in generating the media exposure profile 100. The data station 350 can transmit the media exposure data continuously or intermittently. Intermittent transmissions can occur in response to a triggering event, on a pull basis from the data center 220, upon regularly scheduled intervals, or in accordance with some other transmission protocol.

In other words, the remote control 305 maintains a record of the audience member's television and radio entries and forwards those entries to the data center 220 via the data station 350 and the Internet 235. The data center 220 uses those entries for computing the media exposure profile 100.

Thus, based on the audience member's commands to the set top box 320, the EAAE 225 can populate the analog cable cells 140, the digital cable cells 145, and the satellite cells 150 for both radio and television media types 105, 110. If the set top box 320 also handles open-air radio and television signals, then the EAAE 225 can populate the open-air cells 155 for television media 105 and for radio media 110 with data from the HMI 205.

As an alternative to receiving media exposure data from the remote control 305 via the RF link 352, the set top box 320 can send exposure data to the data station 350 for forwarding to the data center 220. That is, the set top box 320 can be a monitoring instrument that records content exposure data and forwards that data to the data station 350 via a wireless or hardwire link. And, the data station 350 can send the data it receives to the data center 220 as discussed above.

In one exemplary embodiment of the present invention, the Internet 235 sends streaming video to a home appliance that the audience member controls with the remote control 305. The remote control 305 tracks the audience member's streaming video control entries and sends those entries to the data center 220. Thus, the data center 220 and a source of moving images can each have an Internet address and can each be in communication with the HMI 205 via the Internet 235.

Beyond reporting on media exposures associated with the set top box 320, the HMI 205 can track direct interactions between the remote control 305 and a media appliance. That is, the HMI 205 can track the audience member's usage of the remote control 305 for controlling the radio 325 or the television 315 to receive signals that the set top box 320 does not handle. For example, the residence 355 may not have a set top box 320 that handles open-air signals broadcast from a local television or radio station via an antenna anchored to the surface of the earth. A set top box 320 that is present in the residence 355 may fail to emulate open-air channel reception. Or, the television 315 may bypass or not use the set top box 320. In these situations, the remote control 305 can track radio and television exposures in the open-air category 155 of television and radio media types 105, 110 by recording the audience member's control command entries and channel selections.

Further, the residence 335 can have televisions 315 and radios 325 that exclusively receive open air signals, televisions 315 and radios 325 that exclusively receive signals through the set top box 320 or some similar network interface, and other televisions 315 and radios 325 that receive both open-air and set-top-box-based signals. In an exemplary embodiment, the remote control 305 can control all of these appliances. In one exemplary embodiment of the HMI 205, the residence 335 has a plurality of remote controls 305 that each controls a different type of media appliance and that each reports media exposure data to the data center 220 regarding its respective appliance.

In addition to its capabilities for interacting with signal-based media, the remote control 305 comprises a print interface 335 that scans writings 340 associated with print media 115 in the in-home venue 135. Magazines, newspapers 340, mailed circulars, and other printed materials can have an identifier, such as a barcode 345, printed thereon. The remote control 305 can scan items of printed material that the audience member encounters in the residence 355, thereby forming a record of print media exposures that can be integrated into the media exposure profile 100.

In one exemplary embodiment, each writing 340 that constitutes print media 115 in the residences of a sample of audience members has the barcode identifier 345. That is, barcodes 345 are attached to various magazines, phonebooks, mailed materials, newsletters, newspapers 340, etc. that enter the residences 355 of a monitored sample of an audience. The remote control 305 scans those writings 340, records the identities of those writings 340 via information encoded in the barcodes 345, and sends the resulting exposure data to the data center 220 via the data station's Internet connection.

In another exemplary embodiment, barcodes 345 are attached to a representative sample of the writings 340 that enter an audience member's residence 355. In this situation, the remote control 305 tracks those writings 340 with attached barcodes 345. The EAAE 225 uses the resulting exposure data to extrapolate a characterization of the audience member's overall exposure to print media 115 in the in-home venue 135.

The HMI 205 can comprise any of the technologies disclosed in U.S. Patent Application Publication Number 2005/0060232 to Maggio, which is entitled “Method and System for Interacting with a Writing,” the entire contents of which are hereby incorporated as Appendix A and by reference. Thus, an exemplary embodiment of the system 200 can comprise one or more of the hardware elements, software routines, methods, systems, or network architectures disclosed in U.S. Patent Application Publication Number 2005/0060232. Further, the disclosure and teaching of that patent reference can support making and using exemplary embodiments of the present invention, including the remote control 305.

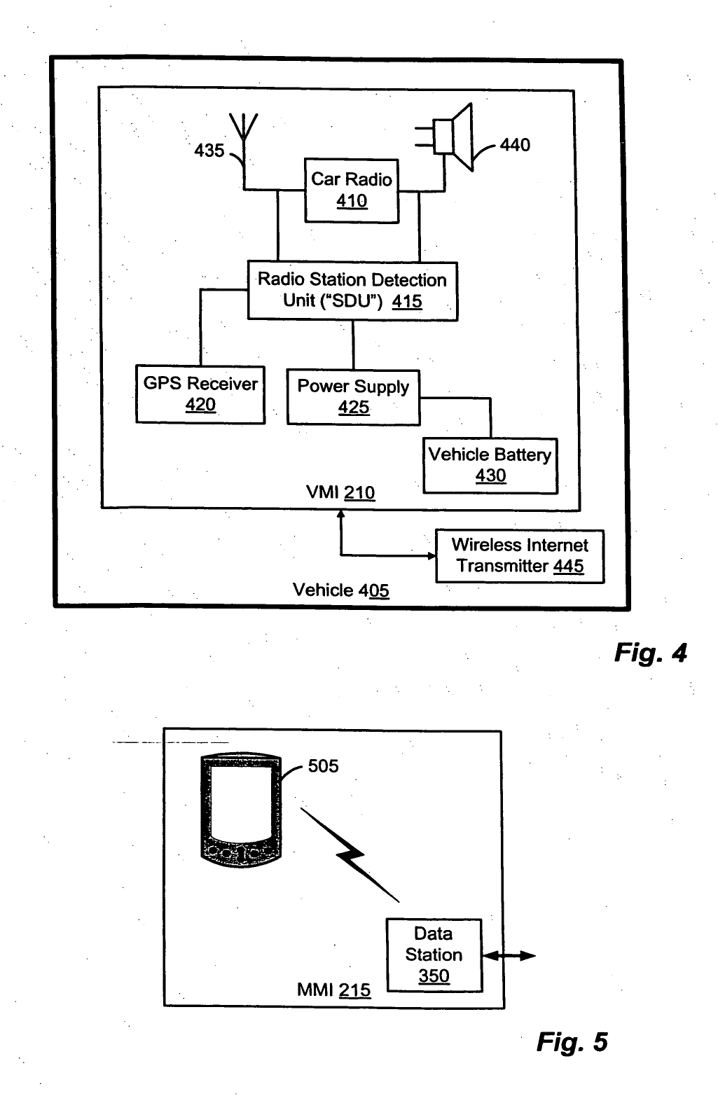

Turning now to FIG. 4, this figure illustrates a functional block diagram of a system 210 for monitoring an audience member's exposure to media while driving or riding in a vehicle 405 in accordance with an exemplary embodiment of the present invention. The system 210 illustrated in FIG. 4 can be an exemplary embodiment of the VMI 210 of the system 200 illustrated in FIG. 2, and will be described as such.

The VMI 210 can monitor the audience member's radio channel selections as he or she drives or rides in the vehicle 405. With this capability, the VMI 210 provides media exposure statistics regarding radio media 110 in the in-vehicle venue 125. The EAAE 225 can use those statistics for constructing the media exposure profile 100. The VMI 210 also has a capability for monitoring exposure to signage media 175 in the in-vehicle venue 125 and for reporting that exposure to the data center 220.

The VMI 210 comprises a radio station detection unit (“SDU”) 415 that connects to the car radio 410, specifically to the car radio's antenna input 435 and its speaker output 440. From these connections, the SDU 415 determines and tracks the channel settings of the car radio 410, as tuned by the audience member. A power supply 425 coupled to the vehicle's battery 430 provides electricity to the SDU 415 and the other components of the VMI 210.

One such other component is a global positioning system (“GPS”) receiver 420 that determines and tracks the vehicle's location. The SDU 415 can integrate the vehicle's GPS location and the channel settings to determine the radio programming to which the audience member is exposed.

Beyond its role in tracking exposure to radio media 110, the GPS receiver 420 can provide a record of the vehicle's location as related to billboards and other signs located along roadways and streets. Thus, the VMI 210 records exposure to print media 115 provided through the signage delivery system 175 in the in-vehicle venue category 125 of the broader out-of-home venue 130.

The VMI 210 can also couple to an in-car television system (not shown in FIG. 4) to monitor in-car television media exposure. In this situation, the in-car television essentially takes the place of the radio 410 in the architecture of the VMI 210 that FIG. 4 illustrates.

In one exemplary embodiment, a car with multiple media appliances onboard has a VMI 210 dedicated to each of those appliances for monitoring respective media exposures. In one exemplary embodiment, the vehicle 405 has an onboard HMI 205 for monitoring exposures associated with magazines, newspapers, satellite radio, satellite television, etc.

The VMI 210 is connected to a wireless Internet transmitter 445 that transmits the exposure data obtained by the VMI 210 to the data center 220 via the Internet 235. The VMI 210 uses exposure data from the VMI 210 to generate the media exposure profile 100 and to populate the profile's relevant cells.

The VMI 210 can comprise any of the technologies disclosed in U.S. Pat. No. 6,934,508 to Ceresoli et al., which is entitled “System and Method for Obtaining Comprehensive Vehicle Radio Listener Statistics,” the entire contents of which are hereby incorporated as Appendix C and by reference. Thus, an exemplary embodiment of the system 200 can comprise one or more of the hardware elements, software routines, methods, systems, or network architectures disclosed in U.S. Pat. No. 6,934,508. Further, the disclosure and teaching of that patent reference can support making and using exemplary embodiments of the present invention, including the VMI 210.

Turning now to FIG. 5, this figure illustrates a functional block diagram of a system 215 for monitoring an audience member's exposure to media in accordance with an exemplary embodiment of the present invention. The system 215 illustrated in FIG. 5 can be an exemplary embodiment of the MMI 215 of the system 200 illustrated in FIG. 2, and will be described as such. The MMI 215 can provide supplemental media exposure data or can function as a catchall for capturing media exposures not otherwise monitored.

The MMI 215 comprises a personal data assistant (“PDA”) 505 and a data station 350. The audience member carries the PDA 505 and manually records media exposure events that are not automatically monitored by the HMI 205 or the VMI 210. Thus, the PDA 505 functions as a media exposure diary that the audience member maintains. Software executing on the PDA 505 can provide a graphical interface that automates many aspects of recording media exposures. For example, such software can provide forms, pop-up windows, check boxes, or menus that facilitate making media exposure entries.

The PDA 505 wirelessly transmits the exposure data that it collects to the data station 350, which provides an interface to the Internet 235. As discussed above with reference to FIG. 3, the data station 350 sends the collected exposure data to the data center 220 via the Internet 235. In one exemplary embodiment, the PDA 505 comprises an internal wireless connection 235 and thereby can directly report its data to the data center 220.

Processes and methods of an exemplary embodiment of the present invention will be further described below with reference to the flowcharts of FIGS. 6, 7, and 8. While the description of those flowcharts will include exemplary reference to elements illustrated in FIGS. 1-5, those processes and methods are not limited to functioning with any specifically referenced elements.

Certain steps in the processes described below must naturally precede others for the present invention to function as described. However, the present invention is not limited to the order of the steps described if such order or sequence does not alter the functionality of the present invention. That is, it is recognized that some steps may be performed before or after other steps or in parallel with other steps without departing from the scope and spirit of the present invention.

The present invention can comprise multiple computer programs which embody the functions described herein and shown in the illustrations, graphical representations, functional block diagrams, and appended flow charts. However, it should be apparent that there could be many different ways of implementing the invention in computer programming, and the invention should not be construed as limited to any one set of computer program instructions. Further, exemplary embodiments of the present invention can comprise a combination of computer-based steps, steps implemented by machines other than computers, and manual steps. Further, a skilled programmer would be able to write a computer program to implement the applicable portions of the disclosed invention without difficulty based on the exemplary graphical representations, functional block diagrams, illustrations, and flow charts and associated description in the application text, for example.

Therefore, disclosure of a particular set of program code instructions is not considered necessary for an adequate understanding of how to make and use the invention. The inventive functionality of any computer program aspects of the present invention will be explained in more detail in the following description in conjunction with the remaining figures illustrating functions and program flow.

Turning now to FIG. 6, this figure illustrates a flow diagram of a process 600 for characterizing an audience's exposure to media in accordance with an exemplary embodiment of the present invention. The Process 600, which is entitled Characterize Audience Exposure, can generate the media exposure profile 100 based on exposure data that the monitoring instruments 205, 210, 215 obtain. Moreover, Process 600 is an example of a method for generating VAST ratings and VAST exposure profiles based on VAST sectors.

At Step 605, HMIs 205 monitor audience exposure to television media 105, radio media 110, and print media 115 in the in-home venue 135. The HMIs 205 are disposed in the respective residences 335 of a set of audience members selected from a broader audience. The data center 220 can select the set at random or based on a selection criterion. The data center 220 can include in the sample set audience members with a specific demographic profile, for example. In one embodiment, a person picks audience members that are likely to fill gaps or blank cells in a media exposure profile. Thus, the monitored audience can comprise a portion of the broader audience that exhibits a trait of specific interest to an advertiser or another business entity.

As discussed above with reference to FIG. 3, the HMIs 205 can determine exposure data by monitoring or tracking an audience member's media interactions. Monitoring those interactions can comprise recording and analyzing signals from a hand-held remote control that interfaces to assorted media appliances 315, 325 and that scans printed materials 340.

At Step 610, each respective HMI 205 sends collected exposure data to the remote data center 220. The HMIs 205 can send the data via the Internet 235, via a data station 350, via a cell phone interface, or via some other communication facility known in the art, for example. The HMIs 205 can report to the data center 220 when or as new exposure data becomes available, on a clock, or in response to an occurrence of a predetermined event.

At Step 615, the VMIs 210 monitor exposures of the selected set of audience members to: print media 115 delivered via the signage delivery system 175 in the in-vehicle venue 125; television media 105 delivered via the open-air delivery system 155 in the in-vehicle venue 125; and radio media 110 delivered via the open-air delivery system 155 in the in-vehicle venue 125. As discussed above with reference to FIG. 4, the VMIs 210 can track exposure based on geographic locations and channel settings of in-car media appliances 410. The GPS receiver 420 or another type of geographic sensor can provide geographical location data. The SDU 415 can determine channel settings by processing signals flowing into and out of the in-car media appliances 410.

At Step 620, each respective VMI 210 sends collected media exposure data to the remote data center 220. Each VMI 210 uses its onboard Internet interface 445 for transmitting that data as new data becomes available, on a timed basis, or in response to an event trigger. Alternatively, the VMI 210 can couple to the data station 350, for example when the vehicle 405 returns to the residence 355 after a trip.

At Step 625, the MMIs 215 monitor exposure for the selected set of audience members to media that the HMIs 205 and the VMIs 210 did not monitor. For example, the MMIs 215 may collect exposure data regarding media exposure events that occur infrequently but that a specific advertiser may have a particular interest in understanding.

The MMIs 215 can be handheld computing devices executing software that facilitates manual entry of exposure data. That is, the MMIs 215 can comprise computer-implemented diaries or logs of exposure events completed by respective audience members.

At Step 630, the MMIs 215 send the exposure data that they collected to the data center 220. The MMIs 215 typically establish a wireless link to the data station 350, which forwards that data to the data center 220 via the Internet 235.

At Step 635, the remote data center 220 receives the media exposure data that the HMIs 205, the VMIs 210, and the MMIs 215 collected for each audience member in the representative set of audience members. The data center's data storage facilities 230 store that received exposure data.

At Step 640, which is entitled Generate Media Exposure Profile, the EAAE 225 of the data center 220 generates a media exposure profile 100 for each of the monitored audience members, for the sampled set of audience members, and/or for the audience as a whole. The EAAE 225 generates one or more of those profiles based on the exposure data that the exposure monitoring instruments 205, 210, 215 obtained. Exposure data obtained via direct monitoring or empirical exposure data can be supplemented or augmented with information derived from demographic profiles, external sources, purchased data, rules based processing of empirical exposure data, inferences, and deductions, for example. FIG. 7 illustrates, as Process 640, an exemplary embodiment of Step 640 of Process 600.

Process 600 can execute Step 640 in response to passage of a predetermined amount of time, when a defined event occurs, or whenever the data center 220 receives a significant amount of new exposure data. Thus, the EAAE 225 can update the media exposure profile 100 intermittently, periodically, on demand, or on a dynamic or real-time basis.

Turning now to FIGS. 7A and 7B, these figures illustrate a flow diagram of a process 640 for generating a profile 100 of an audience's exposure to media in accordance with an exemplary embodiment of the present invention. As discussed above, Process 640 can be an exemplary embodiment of Step 640 in Process 600.

At Step 705, the EAAE 225 identifies the cells in the media exposure profile 100 that the EAAE 225 can populate with data received from the monitoring instruments 205, 210, 215 and the cells that it cannot directly populate with that empirical data. That is, the EAAE 225 determines whether additional data is needed to populate all relevant cells of the profile 100 with meaningful data. The EAAE 225 typically performs this function for each audience member in the monitored sample of audience members.

At Step 710, the EAAE 225 identifies any of the unpopulated cells that can be determined to have no exposure based on a mutually exclusive relationship with another cell or group of cells. For example, if the HMI 205 monitored an audience member interacting with an in-home television 315 during a particular period of time, the EAAE 225 can assume that audience member was not in an out-of-home venue 130 during that time period. In this situation, the EAAE 225 may populate all of the out-of-home cells 130 with a zero for that time period to indicate that no out-of-home exposures occurred.

At Step 715, the EAAE 225 uses a demographic profile of each monitored audience member to populate additional cells with inferred or deduced data or information. The demographic profile can be generated with census information or via a questionnaire completed by the audience member. The audience member's specific identity or name can remain unknown. That is, the audience member can remain anonymous. For example, if an audience member is known to reside in an area that has no colleges within a one-hundred mile radius, the audience member can be assumed to have had no exposure to television media 105 in the dorm segment of the out-of-home venue 130.

If no empirical data is available for an audience member regarding potential exposure to airport signage, for example, the EAAE 225 can populate the airport segment of the signage cell 175 with data derived or inferred from airline industry statistics. Assume that an airline industry trade group publishes tabulated estimates of the amount of time that individuals spend in airports according to income level, sex, and residential zip code. Further, assume the demographic profile of the audience member includes his or her income level, sex, and zip code (without necessarily knowing the audience member's name or precise identity). The EAAE 225 can reference the audience member's income, sex, and zip code to the trade group's statistics to derive an estimated amount of time that the audience member spent in an airport venue being exposed to signage. That estimated time can be inserted into the airport segment of the signage cell 175.

At Step 720, the EAAE 225 populates additional cells of the media exposure profile 100 of each monitored audience member with information derived from empirical data in two or more other cells. For example, suppose a monitored audience member has logged consistent and frequent media exposure events into the MMI 215 for hotel and airport venues. In that situation, the EAAE 225 may infer that the audience member is not a student and thus has not had any media exposures in the dorm venue. Accordingly, the EAAE 225 can populate all of the dorm venue cells of the media exposure profile 100 for that audience member with a zero.

At Step 725, which FIG. 7B illustrates, the EAAE 225 determines which cells are inadequately represented in the sample set. That is, the EAAE 225 identifies any cells that may be void of data because the set of monitored audience members was too small or too selective to include a class of audience members. An advertiser may have an specific interest in that class, for example.

At Step 730, the EAAE 225 populates a representative number of the cells identified at Step 725 with inferred data. For example, suppose no monitored audience member had access to television media 105 provided via an open-air delivery system 155. Further, suppose the open-air channel offerings are a subset of the analog cable offerings. In that situation, the EAAE 225 can use exposure data that the HMI 205 collected from audience members with analog cable to infer exposure data for open-air television 105, 155. More specifically, the EAAE 220 can identify audience members that watched an analog cable television channel within that subset and can populate the open air segment 155 of the television media cells 105 accordingly. Thus, the EAAE 225 can estimate a media exposure that might occur had an appropriate audience sample been chosen. In other words, the system 200 can comprise an operability to emulate media exposure conditions.

At Step 735, the EAAE 225 generates a populated media exposure profile 101 for each audience member in the monitored sample set. The EAAE 225 also generates a combined or aggregate media exposure profile 101 for the sample set of audience members. That is, the EAAE 225 aggregates the media exposure profile data for each individual monitored audience member into an aggregate exposure profile 101 for the set of monitored audience members. The EAAE 225 further generates a populated media exposure profile 101 for the entire audience.

The EAAE 225 can attach demographic data to the media exposure profile 101 of a specific audience member, of a monitored set of audience members, or of the entire audience. In one exemplary embodiment, the media exposure profile 100 presents demographic data on at least axis of a graphical or Cartesian coordinate system 180.

Following Step 735, Process 600 ends.

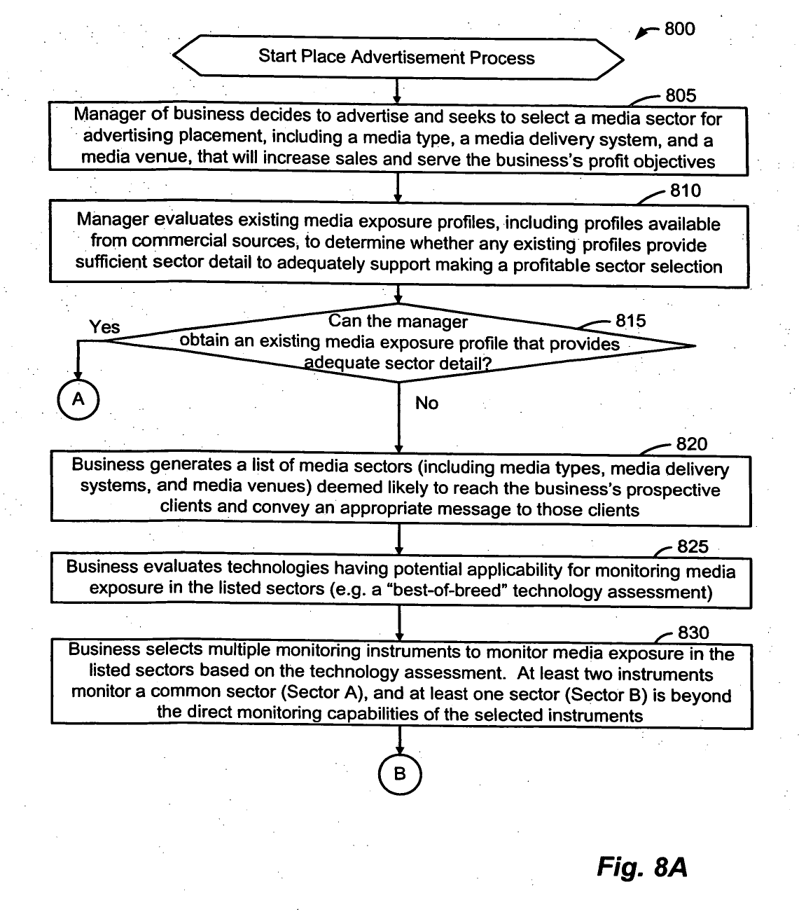

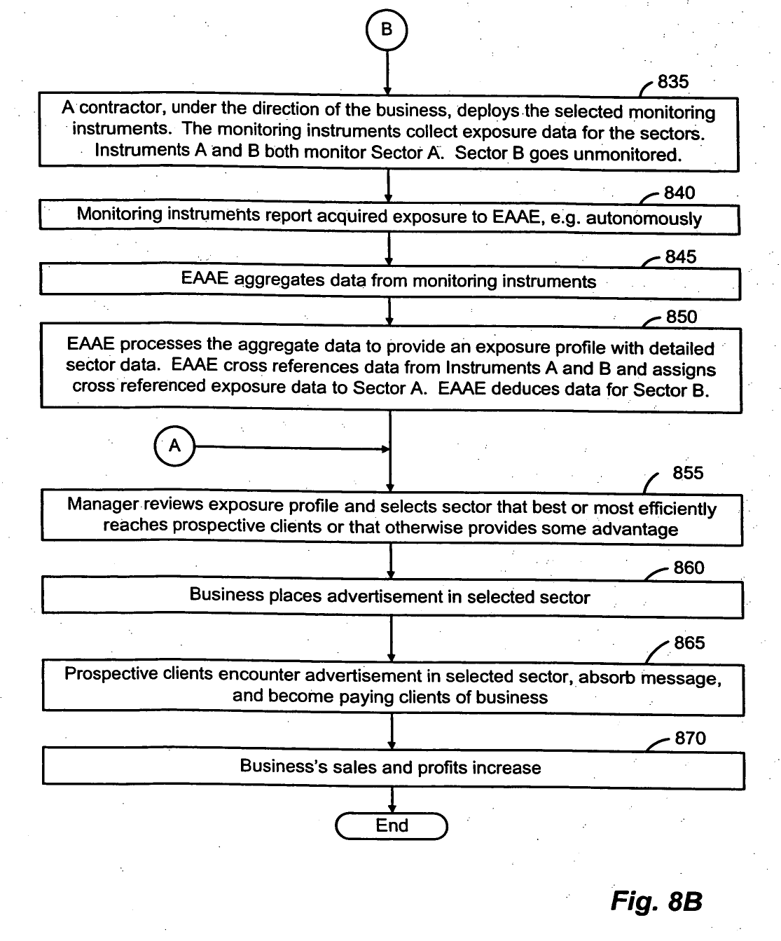

Turning now to FIGS. 8A and 8B, these figures illustrate a flow diagram of a process 800, entitled Place Advertisement, for obtaining an exposure profile 100 and making an advertising decision based on that profile 100 in accordance with an exemplary embodiment of the present invention. Via Process 800, a business entity can generate, or alternatively procure, the media exposure profile 100 and use the profile 100 to select a media sector for placement of an advertisement to yield profit.

At Step 805, a manager of a business decides to establish an advertising campaign as an investment intended to increase sales and/or profits. The manager seeks to select a media sector, including a delivery system 190, a media type 185, and a venue 195, for placement of one or more advertisements associated with the campaign.

At Step 810, the manager evaluates existing media profiles 100 to determine whether any existing profiles 100 are adequate to evaluate media sector alternatives for the campaign. Potential sources of the existing profiles 100 can include commercial ratings vendors and an archive of profiles 100 that the business has previously generated, for example. Thus, the manager determines if the existing exposure data is sufficiently detailed and accurate to support making a sound advertising decision in the current situation. For example, while a limited amount of sector data might be available, that existing data could be out-of-date, could lack sufficient detail, or could be deficient in some other respect.

Decision Step 815 follows Step 810. If the manager can readily obtain an existing media exposure profile 100 that is acceptable, Process 800 branches from Step 815 to Step 855, shown on FIG. 8B and discussed below. If, on the other hand, the manager desires fresh data that provides finer detail or higher accuracy, that represents more sectors, or that is better or more desirable in some other respect than any available existing exposure profiles 100, then Step 820 follows Step 815.

At Step 820, the business compiles a list of media sectors that appear to be likely candidates for reaching the business's potential clients and for delivering the advertising message that the business wishes to convey. For example, the business's marketing department may generate a list of media candidates that includes popular magazines, trade magazines, industry-specific newsletters, newspapers, direct mail, flyers, telemarketing, billboards, satellite television, cable television, open-air television, open-air radio, elevator signage, closed circuit television in an airport, Internet advertising, etc. The business might cull some of the sectors from the list based on an assessment that those sectors would not appropriately convey the business's message or image or would not be appropriate for some other reason. For example, the marketing department of a manufacturer of auto mechanic hand tools might determine that a high-rise office building was not the appropriate venue to advertise its wrenches. Beyond the office building's shortage of potential customers, placement of a wrench advertisement in a high-rise office building could project an inappropriate image.

At Step 825, the business evaluates technologies that are available for monitoring media exposure in the listed media sectors. For example, the business's marketing department or some other party working for the business may consider manual diaries, telephonic surveys, passive observers, acquisition of partial or incomplete ratings data, published industry surveys, set top box monitors, the HMI 205, the VMI 210, the MMI 215, a portable radio with an integral monitoring instrument, etc. The business evaluates candidate technologies in terms of their relative capabilities for acquiring media exposure data for the listed technology sectors. Evaluation criteria might include one or more of sector specificity, level of detail, capability to provide unbiased information, accuracy, precision, repeatability, reliability, lack of time lag, cost, or some other criterion. In other words, the business evaluates multiple technologies to identify one or more “best-of-breed” technologies.

At Step 830, the business selects monitoring instruments for monitoring media exposure in the listed sectors based on the technology evaluations. The business typically selects a plurality of instruments to provide coverage over a plurality of the listed media sectors.

In an exemplary scenario, at least two monitoring instruments, “Instrument A” and “Instrument B,” can collect exposure data from a common sector, “Sector A.” At least one sector, “Sector B,” cannot be directly monitored by any of the selected monitoring instruments. That is, the selected set of monitoring instruments might provide overlapping coverage of Sector A without providing direct coverage of Sector B.

At Step 835, shown on FIG. 8B, the business commissions a contractor or a service provider to deploy the selected set of monitoring instruments. In the exemplary scenario, Instruments A and B both collect empirical exposure data about Sector A, and Sector B goes unmonitored.

At Step 840, the set of deployed monitoring instruments report the media exposure data that they have collected to the EAAE 225. In one exemplary embodiment, the instruments self report the data to the EAAE 225, for example sending the data wirelessly under automatic direction of or control from a computer system.

At Step 845, the EAAE 225 receives and aggregates the exposure data transmitted by the deployed monitoring instruments. In one exemplary situation, the EAAE 225 populates the sectors or cells of the media exposure profile 100 with empirical monitoring data from the instruments; Sector B remains unpopulated with data; and Sector A is represented by empirical exposure data from both Instrument A and Instrument B.

At Step 850, the EAAE 225 processes the aggregate data generated in Step 845 to provide an exposure profile with detailed sector data. The processing can result in a sharper, clearer, more enhanced, or more detailed picture of media exposure, relative to an unprocessed profile of media exposure. That is, the processing can increase the degree of sector resolution beyond the resolution provided by the raw exposure data. Improving the profile's exposure data can be likened to sharpening a digital photograph via image enhancement. Further, data processing methods known in the image enhancement arts can be applied to the raw data in the profile 100 that the instruments have collected.

Continuing with the above example, the exposure data collected by Instrument A can be averaged with the exposure data collected by Instrument B to yield a media exposure value representing Sector A. That is, statistical techniques can be used to compute a media exposure value for Sector A that is more accurate than or is better than the empirical data that Instrument A individually provided and the empirical data that Instrument B individual provided.

An exposure value for Sector B can be deduced by extrapolation or interpolation using empirical data in adjoining or nearby sectors or using data in sectors that share some relationship to Sector B. That is, a statistical technique can generate computed data for insertion in a sector that is otherwise void of empirical data.

Process 640, illustrated in flowchart form in FIG. 7 and discussed above, provides an exemplary method for conducting Steps 845 and 850. That is, the EAAE 225 can execute Process 640, in whole or in part, to generate one or more media exposure profiles 100 that the business can use to make advertising decisions.

At Step 855, the manager reviews the exposure profile 100 and selects the sector that most efficiently reaches the business's prospective clients. For example, the manager may select the sector that has the best exposure rate and/or provides the best value for exposing the prospective clients to the advertising message. An analysis of exposure value could take into account financial considerations, for example.

At Step 860, the business places one or more advertisements in the selected sector. The business may directly place the advertisements or may engage an advertising agency or some other party to place the advertisements, for example.

At Step 865, the prospective clients encounter the placed advertisement through respective media exposures in the selected sector. The prospective clients absorb the advertisement's message, for example becoming immersed in the message. In response to exposure to the message, the prospective clients become paying clients, purchasing goods or services from the business.

At Step 870, in response to increased purchasing activity, the business's sales figures and profits increase. Thus, the business's objectives in selecting the sector and placing the advertisement are met. Following Step 870, Process 640 ends.

Although specific embodiments of the present invention have been described above in detail, the description is merely for purposes of illustration. Various modifications of, and equivalent steps corresponding to, the disclosed aspects of the exemplary embodiments, in addition to those described above, also can be made by those skilled in the art without departing from the spirit and scope of the present invention defined in the following claims, the scope of which is to be accorded the broadest interpretation so as to encompass such modifications and equivalent structures.

What is claimed is:

1. A method for characterizing media exposure for a media type, comprising the steps of:
providing a breakdown of exposure venues and media delivery systems for the media type;
for each of a plurality of the exposure venues, acquiring media exposure data for each of a plurality of the media delivery systems; and
providing a media exposure profile for the media type, covering the plurality of exposure venues and the plurality of media delivery systems, in response to aggregating the acquired media exposure data.

2. The method according to claim 1, wherein the step of acquiring media exposure data comprises acquiring the media exposure data in response to monitoring media exposure in each of the exposure venues for each of the media delivery systems.

3. The method according to claim 1, wherein the breakdown of exposure venues and media delivery systems for the media type comprises an exposure venue and a media delivery system for which additional exposure information is desired regarding the media type, and
wherein the method further comprises the step of inferring the desired additional exposure information.

4. The method according to claim 3, wherein the step of inferring the desired additional exposure information comprises inferring the desired additional exposure information from media exposure data of a different exposure venue and a different media delivery system than the exposure venue and the media delivery system for which additional exposure information is desired.

5. The method according to claim 4, further comprising the steps of:
deploying a media monitoring instrument in the different exposure venue for the different media delivery system; and
receiving media exposure data from the deployed media monitoring instrument.

6. The method according to claim 3, wherein the step of inferring the desired additional exposure information comprises inferring the desired additional exposure information from media exposure data specific to at least two different exposure venues and at least two different media delivery systems than the exposure venue and the media delivery system for which additional exposure information is desired.

7. The method according to claim 1,
wherein the media type comprises television,
wherein the plurality of exposure venues comprises an in-home venue and an out-of-home venue, and
wherein the plurality of media delivery systems comprises an analog cable media delivery system and a digital cable media delivery system.

8. The method according to claim 7, wherein the out-of-home venue comprises an in-vehicle venue and an out-of-vehicle venue.

9. The method according to claim 8, wherein the out-of-vehicle venue comprises an airport venue, a dormitory venue, an office tower venue, and a subway venue.

10. The method according to claim 8, wherein the plurality of media delivery systems further comprises a satellite media delivery system and an open-air media delivery system.

11. The method according to claim 1, wherein the step of aggregating the acquired media exposure data comprises aggregating industry statistics, data purchased from a plurality of sources, and data acquired from a monitoring instrument.

12. The method according to claim 1, wherein the step of aggregating the acquired media exposure data comprises the steps of:
an aggregator identifying candidate sources of media exposure data; and
the aggregator selecting specific sources from the candidate sources.

13. The method according to claim 12, wherein the step of the aggregator selecting specific sources from the candidate sources comprises the aggregator selecting a specific source from the candidate sources based on a comparison between exposure monitoring technologies of the candidate sources.

14. The method according to claim 12, wherein the step of the aggregator selecting specific sources from the candidate sources comprises the candidate sources competing among one another for the selection.

15. The method according to claim 12, wherein the step of the aggregator selecting specific sources from the candidate sources comprises making selections in an environment of competition between the candidate sources.

16. The method according to claim 1, wherein the step of acquiring media exposure data comprises:
a participant in a media survey wearing a radio frequency identification tag that uniquely identifies the participant;
a chipset in a portable radio carried by the participant identifying content played by the portable radio; and
based on signals from the radio frequency identification tag and the chipset, a wireless transmitter coupled to the portable radio transmitting a wireless signal to a remote data recoding and analysis site, wherein the wireless signal conveys an identification of the content and the participant.

17. A method for characterizing media exposure, comprising the steps of:
providing a breakdown of media exposure according to media type, exposure venue, and media delivery system;
acquiring media exposure data for each of a plurality of the media types, a plurality of the exposure venues, and a plurality of the media delivery systems; and
populating the breakdown with the acquired media exposure data.

18. The method according to claim 17, wherein the step of populating the breakdown further comprises determining media exposure for a first media type, a first exposure venue, and a first media delivery system based on making an inference from empirical exposure data regarding a second media type, a second exposure venue, and a second media delivery system.

19. The method according to claim 17, wherein the step of populating the breakdown further comprises inferring media exposure for a first media type, a first exposure venue, and a first media delivery system based on empirical exposure data regarding a second media type, a second exposure venue, a second media delivery system, a third media type, a third exposure venue, and a third media delivery system.

20. The method according to claim 17, wherein the step of acquiring media exposure data comprises the steps of:
a participant in a media survey wearing a radio frequency identification tag unique to the participant;
a chip in a portable media device associated with the participant identifying content played by the portable media device; and
sending an identification of the content and the participant over air from the portable media device to a remote site.

21. A method for characterizing media exposure, comprising the steps of:
segmenting media exposure according to media type, venue, and delivery system;
obtaining media exposure data in response to monitoring media exposure for a plurality of media types, exposure venues, and delivery systems; and
generating a media exposure profile, for the media exposure segments, based on the obtained media exposure data.

22. The method according to claim 21, wherein the step of monitoring media exposure comprises selecting businesses, from a pool of competitors, to monitor media exposure based on a technology assessment of the competitors.

23. A method for profiling media exposure, comprising the steps of:
providing a system for characterizing media exposure in terms of sectors, wherein respective combinations of media type, media delivery system, and exposure venue distinguish the sectors from one another;
monitoring media exposures for a plurality of media types, a plurality of delivery systems, and a plurality of exposure venues; and
generating a media exposure profile in response to populating a plurality of the sectors with media exposure data according to the monitored media exposures.

24. The method according to claim 23, further comprising the steps of:
identifying a sector in the generated media exposure profile that has a deficit of media exposure data; and
populating the identified sector with inferred media exposure data.

25. The method according to claim 23,
wherein the media delivery system specifies a category of technology that conveyed an advertisement from a remote location to a place of exposure, and
wherein the exposure venue specifies the place of exposure by category.

26. The method according to claim 25, wherein the media type specifies whether content is physical or electronic in form.

27. The method according to claim 23,
wherein the media type specifies whether content is television content, radio content, or print content,
wherein the exposure venue specifies whether exposure of content occurs in an airport, a home, a dorm, or a vehicle, and
wherein the media delivery system specifies whether content is delivered via analog cable, digital cable, satellite, or open air.

28. A method for characterizing media exposure, comprising the steps of:
selecting an individual to participate in a media exposure program;
monitoring media exposure of the selected individual to a plurality of media sectors, each comprising a respective media type, a respective delivery system, and a respective venue;
identifying another media sector for which additional media exposure information for the selected individual is desired beyond the monitored media exposure; and
inferring the additional media exposure information for the selected individual.

29. The method according to claim 28, wherein the step of inferring the additional exposure information comprises inferring the additional exposure information based on the monitored media exposure.

30. The method according to claim 28, wherein the step of inferring the additional exposure information comprises inferring the additional exposure information based on published demographic information.

31. The method according to claim 28, wherein the step of inferring the additional exposure information comprises inferring the additional exposure information based on a statistical average.

32. The method according to claim 28, wherein the step of inferring the additional exposure information comprises inferring the additional exposure information based on media exposure information regarding another individual.

33. The method according to claim 28,
wherein one of the media sectors has television as a media type,
wherein one of the media sectors has radio as a media type,
wherein one of the media sectors has print as a media type,
wherein one of the media sectors has in-home as a venue,
wherein one of the media sectors has out-of-home as a venue,
wherein one of the media sectors has satellite as a delivery system,
wherein one of the media sectors has analog cable as a delivery system,
wherein one of the media sectors has digital cable as a delivery system, and
wherein one of the media sectors has open-air as a delivery system.

34. The method according to claim 28, wherein the step of monitoring media exposure for the selected individual comprises:
monitoring in-home media exposure of the selected individual via a first monitoring instrument;
monitoring in-vehicle exposure of the selected individual via a second monitoring instrument; and
monitoring exposure of the selected individual outside a home environment and outside a vehicle environment via a third monitoring instrument.

35. The method according to claim 28, further comprising the step of generating a media exposure profile for an audience in response to aggregating the inferred media exposure information and the monitored media exposure information of the selected individual with media exposure information of other individuals.

36. A method for producing a media exposure profile for an audience, comprising the steps of:
providing a system for describing media exposure according to a first indicator of media type, a second indicator of delivery technology, and a third indicator of venue;
selecting a plurality of individuals to participate in a media exposure study;
for each individual in the plurality of selected individuals, assigning values to each of the first indicator, the second indicator, and the third indicator in response to monitoring each individual with a plurality of monitoring instruments; and
producing an aggregate profile for the audience according to the assigned values for each individual in the plurality of selected individuals.

37. The method according to claim 36, wherein monitoring each individual with a plurality of monitoring instruments comprises, for each respective individual in the plurality of individuals:
a first dedicated instrument tracking media exposure in a residence of the respective individual;
a second dedicated instrument tracking media exposure in a vehicle of the respective individual; and
a third dedicated instrument tracking media exposure beyond the media exposure that the first and the second dedicated instrument track.

38. The method according to claim 37, wherein the third dedicated instrument comprises an electronic diary.

39. The method according to claim 38, wherein the second dedicated instrument is operative to identify stations to which a radio in the vehicle is tuned.

40. The method according to claim 39, wherein the first dedicated instrument comprises a remote control.

41. The method according to claim 36, further comprising the steps of:
identifying a media sector, defined by a specific media type, a specific delivery technology, and a specific venue, for which additional media exposure information is desired regarding a specific individual in the plurality of selected individuals; and
inferring the desired media exposure information.

42. The method according to claim 41, wherein the step of inferring the desired media exposure information comprises inferring the desired media exposure for the specific individual based on a result of monitoring another specific individual in the plurality of selected individuals.

43. The method according to claim 41, wherein the step of inferring the desired media exposure information comprises inferring the desired media exposure for the specific individual based on demographic information obtained from a ratings bureau.

44. The method according to claim 41, wherein the step of inferring the desired media exposure information comprises inferring the desired media exposure for the specific individual in the identified media section based on media exposure information for the specific individual.
